(19) United States
(12) Patent Application Publication
(10) Pub. No.: US 2013/0085067 A1
(43) Pub. Date: Apr. 4, 2013

(54) MODIFIED SOPHOROLIPIDS FOR THE INHIBITION OF PLANT PATHOGENS

(71) Applicant: Polytechnic Institute of New York University, Brooklyn, NY (US)

(72) Inventors: Mark H. Schofield, Washington, DC (US); Thavasi Renga Thavasi, Ozone Park, NY (US); Richard A. Gross, Plainview, NY (US)

(73) Assignee: Polytechnic Institute of New York University, Brooklyn, NY (US)

(21) Appl. No.: 13/644,563

(22) Filed: Oct. 4, 2012

Related U.S. Application Data
(60) Provisional application No. 61/543,122, filed on Oct. 4, 2011.

(51) Int. Cl. A01N 43/16; A01P 13/00; A01P 7/04; A01P 15/00; A01P 3/00; A01P 1/00

(52) U.S. Cl. 504/292; 514/25

(57) ABSTRACT

A method for controlling pests by modifying derivatives of sophorolipids (SL) and applying the modified sophorolipid derivatives (MSL) to the plant pathogen or to an environment in which the pathogens may occur or are located in an amount such that the pathogens are substantially controlled.

### STATEMENT OF RELATED APPLICATIONS

This application claims the benefit of and priority on U.S. Provisional Patent Application No. 61/543,122 having a filing date of Oct. 4, 2011.

### BACKGROUND OF THE INVENTION

1. Technical Field

The present invention relates generally to the field of sophorolipids (SL) and more specifically to new compositions of matter for uses of modified sophorolipids (MSL) as antibacterial and antifungal agents in agricultural applications, such as biopesticides against plant pathogens.

2. Prior Art

Nature has evolved a class of compounds known as sophorolipids that have antimicrobial properties. These natural biopesticides, which can be classified as microbial surfactants, are amphiphilic molecules produced by fermentation using substrates consisting of carbohydrates and lipids. Microbial biosurfactants are surface active compounds produced by various microorganisms. They lower surface and interfacial tension and form spherical micelles at and above their critical micelle concentration (CMC). Microbial biosurfactants generally have an amphiphilic structure, possessing a hydrophilic moiety, such as an amino acid, peptide, sugar or oligosaccharide, and a hydrophobic moiety including saturated or unsaturated lipid or fatty acids. Sophorolipids are a class of glycolipid biosurfactant (FIG. 1) produced by yeasts, such as Candida bombicola, Yarrowi alipolytica, Candida apicola, and Candida bogoriensis.

Sophorolipids consist of a hydrophilic carbohydrate head, sophorose, and a hydrophobic fatty acid tail with generally 16 or 18 carbon atoms with saturation or un-saturation. Sophorose is an unusual disaccharide that consists of two glucose molecules linked β-1,2. Furthermore, sophorose in sophorolipids can be acetylated on the 6′- and/or 6″- positions (FIG. 1). One fatty acid hydroxylated at the terminal or subterminal (β-1) positions is β-glycosidically linked to the sophorose molecule. The fatty acid carboxylic acid group is either free (acidic or open form) or internally esterified generally at the 4″-position (lactonic form) (FIG. 1). The hydroxy fatty acid component of sophorolipids generally has 16 or 18 carbon atoms with generally one unsaturated bond. However, the sophorolipid fatty acid can also be fully saturated. As such, sophorolipids synthesized by C. bombicola consist of a mixture of molecules that are related. Differences between these molecules are found based on the fatty acid structure (degree of unsaturation, chain length, and position of hydroxylation), whether they are produced in the lactonic or ring-opened form, and the acetylation pattern.

Work has been carried out to “tailor” sophorolipid (SL) structure during in vivo formation. These studies have mainly involved the selective feeding of different lipophilic substrates. For example, changing the co-substrate from sunflower to canola oil resulted in a large increase (50% to 73%) of the lactonic portion of SLs. Also, unsaturated C-18 fatty acids of oleic acid may be transferred unchanged into sophorolipids. Finally, lactonic and acidic sophorolipids are synthesized in vivo from stearic acid with similar yields to oleic acid-derived sophorolipids. Thus, to date, physiological variables during fermentations have provided routes to the variation of sophorolipid compositions.

As noted above, fermentation by different microorganisms, Candida bombicola, Yarrowi alipolytica, Candida apicola, and Candida bogoriensis, leads to sophorolipids of different structure noted above, the variations in sophorolipids based on fatty acid feedstocks and organisms leads to a wide array of sophorolipids including lactonic and acidic structures. An additional modification that is relevant to acidic sophorolipids is cleavage of the sophorose moiety to the corresponding glucose-based glucolipids. Treatment of acidic sophorolipids with enzymes β-glucuronidase (Helix pomatia), cellulase (Penicillium funiculosum), Clara diastase (a mixture of enzymes including amylase, cellulase, peptidase, phosphatase, and sulphatase), galactomannanase (Aspergillus niger), hemicellulase (Aspergillus niger), hesperidinase (Aspergillus niger), inulinase (Aspergillus niger), pectolyase (Aspergillus japonicus), or naringinase (Penicillium decumbens) afford glucolipids over a range of pH values.

The chain length of the fatty acid carbon source fed can result in changes in the predominant fatty acid incorporated into the sophorolipid produced. For example, it has been found that when hexadecane and octadecane were fed in fermentations, over 70% of the hydroxylated fatty acids found in sophorolipids were hexadecanoic and octadecanoic acids, respectively. When shorter alkanes such as tetradecane are fed as substrates in fermentations, only a minor fraction of the sophorolipids produced by the organism consist of the corresponding hydroxylated shorter chain fatty acid. Instead, the vast majority of these shorter chain fatty acids are elongated to either C16 or C18 fatty acids. Similarly, when longer alkanes such as eicosane (C20) are fed to the sophorolipid producing organism, generally longer chain fatty acids are metabolized via β-oxidation to shorter chain length hydroxylated C16 and C18 fatty acids.

Furthermore, the degree of lactonization of sophorolipids and acetylation of the sophorose polar head may be influenced by the carbon source fed during sophorolipid production. For example, it has been found that sophorolipids derived from rapeseed, sunflower and palm oils rich in C18:0 and C18:1 fatty acids are formed with higher levels of diacetylated lactones than sophorolipids produced from the corresponding fatty acid ester feedstocks.

It is known that by modification of sophorolipids, their physical properties can be manipulated. Modifications of SLs were performed so that the chain length of the n-alkyl group (methyl, ethyl, propyl, butyl, and hexyl) esterified to the sophorolipid fatty acid was varied. The effect of the n-alkyl ester chain length on interfacial properties of corresponding sophorolipid analogues was studied.

The cmc and minimum surface tension have an inverse relationship with the alkyl ester chain length. That is, cmc decreased to ½ per additional CH₂ group for the methyl, ethyl, and propyl series of chain lengths. These results were confirmed by fluorescence spectroscopy. Adsorption of sophorolipid alkyl esters on hydrophilic solids was also studied to explore the type of lateral associations. These surfactants were found to absorb on alumina but much less on silica. This adsorption behavior on hydrophilic solids is similar to that of sugar-based nonionic surfactants and unlike that of nonionic ethoxylated surfactants. Hydrogen bonding is proposed to be the primary driving force for adsorption of the sophorolipids on alumina. Increase in the n-alkyl ester chain length of sophorolipids caused a shift of the adsorption isotherms to lower concentrations. The magnitude of the shift corresponds to the change in cmc of these surfactants. This study suggests that by careful modulation of sophorolipid structure via simple chemical modification, dramatic shifts in their surface-activity can be achieved to ‘tune’ their properties for a desired interfacial challenges.

It has been shown that modified sophorolipids have antibacterial, antiviral, and anti-inflammatory properties. In one example, sophorolipids were shown to down-regulate expression of proinflammatory cytokines including interleukin. Furthermore, as shown in Table 1, the antibacterial activity of sophorolipids can be increased by up to 1000 times relative to the natural SL mixture by simple modifications such as esterification of fatty acid carboxyl groups and selective acetylation of disaccharide hydroxyl groups. However, structures found active for these applications have low activity and are not useful as actives to kill and stop the growth of plant pathogenic organisms. Therefore, one skilled in the art could not anticipate modifications of sophorolipids that are required to obtain sophorolipid derivatives useful as biopesticidal agents.

TABLE 1
Antibacterial activity of SLs against human pathogens

| | Compound codes | | | | | |
|---|---|---|---|---|---|---|
| Pathogens | 13 | 3 | 9 | 10 | 6 | 1 |
| | Minimum Inhibitory Concentration | | | | | |
| | 100 (MIC₁₀₀) in mg/mL | | | | | |
| Escherichia coli | 1.67 | 5 | 5 | 5 | 1.67 | 5 |
| Moraxella sp. | 1.67 | 5 | 2.05 × 10⁻² | 6.17 × 10⁻² | 6.17 × 10⁻² | 5 |
| Ralstonia eutropha | 5 | 5 | 5 | 5 | 5 | 5 |
| Rhodococcocus | N/A | 0.56 | 6.86 × 10⁻³ | 5 | 5 | 5 |
| erythropolis | | | | | | |
| Salmonella | 5 | 5 | 5 | 5 | 1.67 | 5 |
| choleraesuis | | | | | | |

Note: All values in Table 1 are mg/mL. “Natural SL”, compound 1, refers to the mixture of acidic and latonic sophorolipids obtained from fermentation. Structures of sophorolipids are shown in FIGS. 1, 6, 7, 8, and 9. MIC₁₀₀ means the minimum inhibition concentration at which 100% growth inhibition observed. Names of compounds discussed in this Table are given below.
6 Ring-opened SL-methyl ester
9 Ring-opened SL-ethyl ester, 6″-acetyl
10 Ring-opened SL-ethyl ester, 6′,6″-diacetyl
13 Ring-opened SL-ethyl ester, 6′-acetyl
3 open chain SL free acid
1 Natural sophorolipid mixture

U.S. agriculture heavily relies on chemical pesticides for the eradication of plant pathogens. Each year farmers around the world spend approximately $40 billion on chemical pesticides whose use, while valuable for the control of plant pathogens, poses significant environmental problems. Chemical pesticides harm non-target organisms including humans, domestic animals, beneficial insects, microbes and wildlife. Pesticide residues often remain on crops and accumulate in soil, water, and air. Chemical pesticides are almost exclusively petroleum-based which does not fit with current demands for products with increased bio-based content and eco-friendliness.

Biopesticides are generally segregated into microbial (fungal, bacterial and viral) and biochemical which include plant and insect growth regulators, pheromones, minerals, plant extracts and microbial extracts. Microbes have evolved natural chemical defense compounds that can be used for the control of microbial plant pathogens. One broad family of these compounds, microbial surfactants, are amphiphilic molecules produced typically from renewable feedstocks such as carbohydrates and lipids by fermentation processes. They exist with a wide range of structures and are non-toxic or less toxic than chemical surfactants. Their natural occurrence in soil allows rapid acceptance from ecological and social viewpoints.

Existing data suggests that sophorolipids may be useful as antimicrobial agents, in the treatment of sepsis and septic shock, as virucidal and spermicidal agents, and as antifungal agents. However, there are no examples in the patent or chemical literature of systematic chemical or enzymatic modifications to improve the antifungal activity of sophorolipids. See U.S. Pat. No. 7,772,193; U.S. Pat. No. 7,262,178; U.S. Provisional patent application Ser. No. 11/020,683 filed Dec. 22, 2004; U.S. Provisional patent application Ser. No. 12/360,486 filed Jan. 27, 2009.

Previous studies have been made on biopesticide activity of microbial and chemical biosurfactants. Several ionic and non-ionic chemical surfactants as well as fungicides azoxystrobin (Quadris) and 1,2,3-benzothiadiazole-7-carbothioic acid S-methyl ester (Actigard) in greenhouse and field tests have been investigated. Indeed, several surfactants were shown to be highly effective in controlling white rust disease of spinach, caused by the Oomycete pathogen Albugo occidentalis (FIG. 2). Several of these compounds are also effective on downy mildew of spinach, caused by the Oomycete pathogen Peronospora farinosa. These two pathogens are of greatest importance worldwide in protecting spinach crops.

Other researchers have studied the use of microbial biosurfactants as safe and effective biopesticides. For example, while investigating control of root rot fungal infections on cucumbers and peppers caused by Pythium aphanidermatum and Phytophthora capsici, lysis of fungal zoospores has been observed. It has been postulated that cell lysis was due to a microbial surfactant in the nutrient solution. Subsequently, the bacterium was found to be Pseudomonas aeruginosa, a rhamnolipid (FIG. 3) biosurfactant producer. It was established that rhamnolipids have zoosporicidal activity against species of Pythium, Phytophora, and Plasmopara at concentrations ranging over 5 to 30 μg/mL. Rhamnolipids are believed to intercalate with and disrupt plasma membranes. Indeed, EPA Presidential Green Chemistry Awards were recently presented to Agraquest Inc. and Jeneil Biosurfactant Companies for their work in developing rhamnolipid and lipopeptide biopesticide products, respectively. As mentioned above, rhamnolipids were found to be effective biopesticides and these results led to their commercialization by Jeneil Biosurfactants Co., LLC. However, the highest volumetric yields of rhamnolipids thus far reported is 45 g/L, which is more than an order of magnitude lower than volumetric yields obtainable during sophorolipid fermentations (700 g/L). These facts, along with the phase separation of sophorolipids in fermentors which allows for their solvent-free isolation from fermentation broths, lead us to conclude that sophorolipids can be produced at lower costs than rhamnolipids.

It has been reported that the sophorolipid natural mixture (non-chemically modified) is active against fungal plant pathogens Phytophthora sp. and Pythium sp. that are responsible for dumping-off disease. Inhibition of mycelial growth and zoospore motility was observed at high concentrations (200 mg/L and 50 mg/L, respectively). Thus, natural sophorolipids may be economically produced but have relative low activity against plant pathogen strains.

The novel derivatives of sophorolipids described herein widely expand the range of use of sophorolipids in the amelioration of the effects of economically important plant pathogens.

### BRIEF SUMMARY OF THE INVENTION

Briefly stated, the present invention is new sophorolipid analog compositions of matter that can be used to kill or inhibit the growth of plant pathogenic bacteria and fungi. Sophorolipids derivatives disclosed herein are described based on the predominant fatty acid constituent, 17-hydroxyoleic acid, produced by C. bombicola when fed crude oleic acid as its fatty acid source. However, because changes in the lipid feed (canola oil and rapeseed oil) lead to different sophorolipids as described above, variations in feedstock also will result in changes in composition of modified sophorolipid structures that are disclosed herein.

New sophorolipids and sophorolipid analogs disclosed herein include those having the formulas shown in FIG. 4 and having the structure:

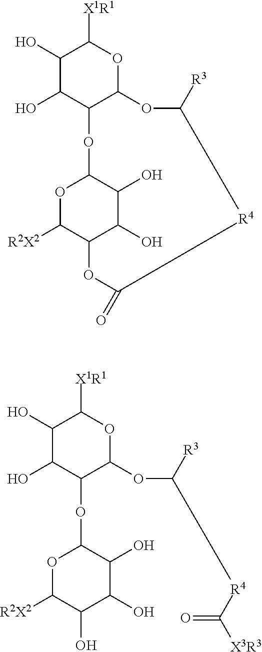

where X¹=X²=CH₂

In one embodiment:
X¹ or X² can be oxymethyl (—CH₂O—) or methylene (—CH₂—);
R¹ and/or R² can be selected from the following functional groups: hydrogen, acetyl, acryl, urethane, hydroxyalkyl, ether, halide, carboxyalkyl or alkyl containing heteroatoms (1°, 2°, and 3° amino, tetraalkylammonium, sulfate, phosphate);
Alternatively, X¹ or X² can be carbonyl (—C═O—) and R¹ and/or R² can be selected from the following groups: hydroxyl, amide, alkanamide, alkanamide containing heteroatoms (1°, 2°, and 3° amino, tetraalkylammonium), alkylsulfate, alkylphosphate, carbohydrate, mono- or oligopeptide;
R³ can be a hydrogen or alkyl group;
R⁴ is an alkyl chain that normally has 15 carbons but can have between 9 and 19 carbons and normally has unsaturation (C═C bond) at one or more sites. Derivatives in this invention include modifying unsaturated (C═C) bonds within R⁴ to be saturated (by hydrogenation), epoxidized, hydroxylated (by hydrolysis of the epoxide or hydroboration oxidation or dihydroxylation using osmium tetroxide), or converted to a dithiirane, alkyl aziridine, cyclopropyl, thioalkane derivative. The methods involved in performing these chemical transformations are well known to those skilled in the art;
X³ can contain heteroatoms (e.g., O, S, NH); and
The combination of X³R³ can be selected from the following functional groups:

hydroxy, alkanethiolate, amide, alkanamide, alkanamide containing heteroatoms (1°, 2°, and 3° amino, tetraalkylammonium), alkylsulfate, alkylphosphate, carbohydrate, mono- or oligopeptide with 2-50 amino acids.

What was surprising and is disclosed in this invention is that sophorolipid modifications can be used to develop valuable compounds with activity against plant pathogenic organisms for use in biopesticidal applications.

The new sophorolipid compounds disclosed herein are unique in structure relative to known sophorolipid derivatives in previous art and were discovered to be highly effective against commercially important plant pathogens. Currently, natural sophorolipids may be economically produced but have relative low activity against plant pathogen strains. The present invention discloses a solution to this problem that involves the discovery of sophorolipid derivatives that enhance product activities against commercially important plant pathogen organisms.

### BRIEF DESCRIPTION OF THE FIGURES

FIG. 1 illustrates a structure of lactonic and open chain (acidic) forms of sophorolipid mixture produced by Candida bombicola.

FIG. 2 is a photograph of the lysis of Albugo occidentalis zoospores by synthetic biosurfactants in combination with fungicide.

FIG. 3 illustrates structures of natural rhamnolipids produced by Pseudomonas aeruginosa.

FIG. 4 are formulas for new sophorolipids and sophorolipid analogs of the present invention.

FIG. 5 illustrates sophorolipids in the lactonic form.

FIG. 6 illustrates sophorolipids in the open chain (acidic) form.

FIG. 7 illustrates representative ester derivatives of the open chain form.

FIG. 8 illustrates amide and related derivatives of the open chain form.

FIG. 9 illustrates derivatives of the C═C (double bond) in the lactonic and open chain forms.

FIG. 10 illustrates derivatives in which the C═C (double bond) in the lactonic and open chain forms have been hydrogenated.

FIG. 11 illustrates peptide derivatives of the open chain form.

FIG. 12 illustrates trans alkylidenation derivatives of lactonic and open chain SLs.

FIG. 13 illustrates electrophile derivatives at sophorose ring.

FIG. 14 illustrates the effect of SL derivatives on zoospores of downy mildew pathogen Plasmopara viticola.

### DETAILED DESCRIPTION OF PREFERRED EMBODIMENTS

Embodiments of this invention are based on the discovery that the administration of pure sophorolipid components of natural mixtures, sophorolipid derivatives, mixtures of different sophorolipid derivatives and mixtures of sophorolipid derivatives with natural sophorolipid compounds can reduce the proliferation of plant pathogenic bacteria, fungi and their spores and zoospores. Embodiments of this invention include pure sophorolipids and/or new sophorolipid analogs as well as mixtures of sophorolipids and/or their derivatives. Embodiments of this invention also include carrying out two or more of the described modification methods on sophorolipid molecules so that changes in structure are carried out at multiple sites of sophorolipid molecules. Furthermore, the reduction of proliferation of plant pathogenic bacteria, fungi and their spores and zoospores can be further enhanced through formulation of individual or combinations of two or more sophorolipid derivatives and pure sophorolipid components. Embodiments of this invention include formulation of modified sophorolipids with inert ingredients as listed in EPA's eligible inert ingredients list (http://www.epa.gov/opprd001/inerts/section25b_inerts.pdf) and any other material that could be used as an inert ingredient in the future. New sophorolipid derivatives are disclosed herein that further expand the range of modified sophorolipids that can be used in the above applications.

This invention also incorporates additional variations in sophorolipid structures beyond those disclosed herein that does not depart from the scope and spirit of the invention.

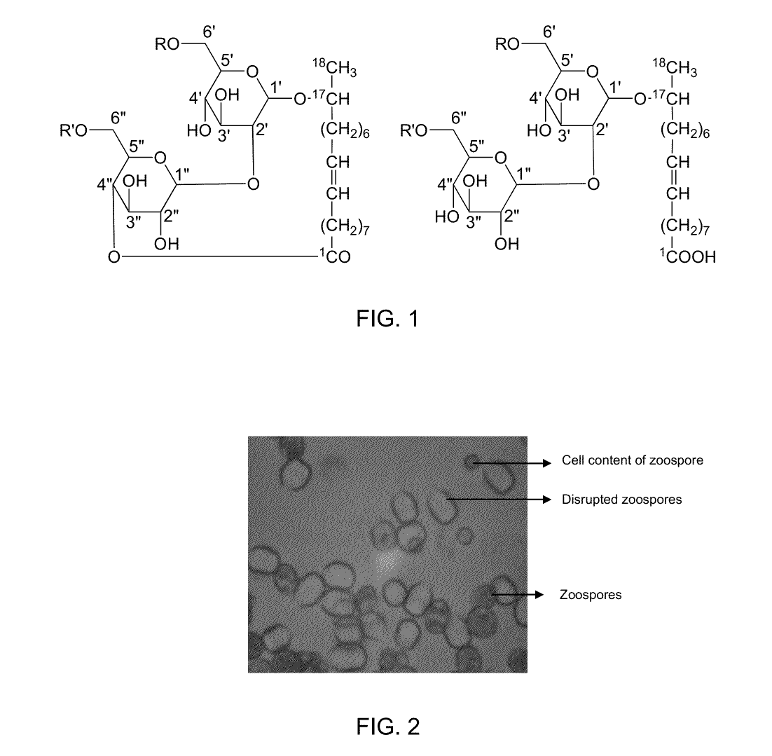

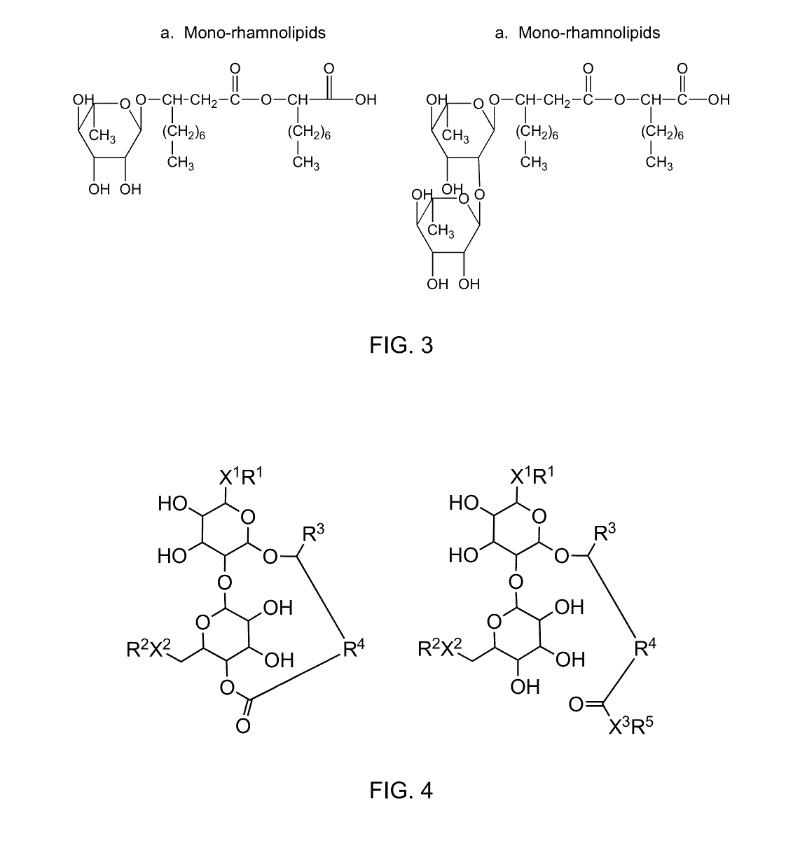

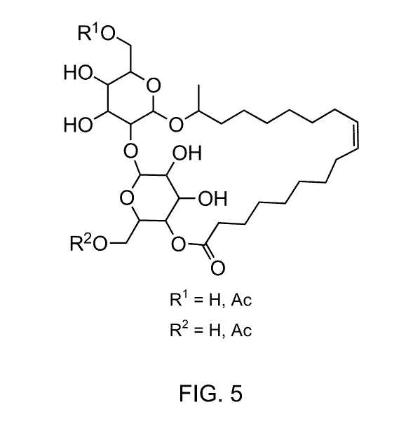

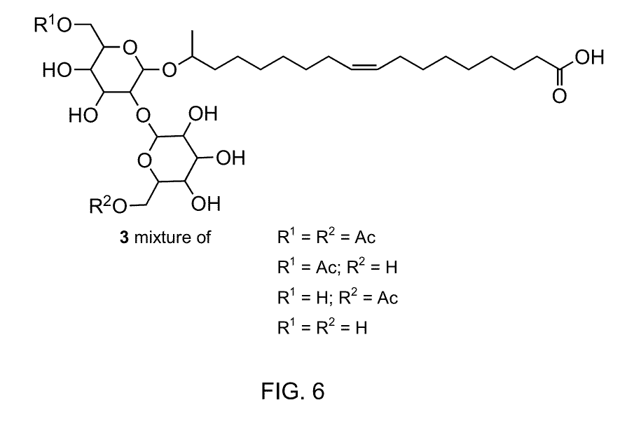

The bio-based and modified sophorolipids that comprise the present invention are obtained from pure fatty acids, fatty acid mixtures, pure fatty acid ester, mixtures of fatty acid esters, and triglycerides along with carbohydrate sources such as corn syrup, dextrins and glucose using a fermentation process comprising a wild-type or engineered yeast strain such as Candida bombicola. These sophorolipids generally consist of a hydrophilic carbohydrate head, sophorose, and a hydroxylated fatty acid tail with 16 or 18 carbon atoms with saturation and unsaturation. Sophorose is an unusual disaccharide that consists of two glucose molecules linked β-1,2. Furthermore, sophorose in sophorolipids can be acetylated on the 6′- and/or 6″- positions (FIG. 1).

The hydrophobic fatty acid tail of sophorolipids normally is hydroxylated at the terminal or subterminal positions and is β-glycosidically linked to the sophorose molecule (the polar head group). The fatty acid carboxylic acid group is either free (acidic or open form) or internally esterified generally at the 4″-position (lactonic form). The hydroxy fatty acid component of sophorolipids generally has 16 or 18 carbon atoms with generally one unsaturated bond. However, the sophorolipid fatty acid can also be fully saturated. As such, sophorolipids synthesized by C. bombicola consist of a mixture of molecules that are related. Differences between these molecules are found based on the fatty acid structure (degree of unsaturation, chain length, and position of hydroxylation), existing in the lactonic or ring-opened form, and the acetylation pattern. Sophorolipids derivatives disclosed herein are described based on the predominant fatty acid constituent, 17-hydroxyoleic acid, produced by C. bombicola when fed crude oleic acid or rapeseed oil or canola oil as its fatty acid source. However, sophorolipid derivatives disclosed herein can be produced by using sophorolipids prepared from a wide range of other fatty acid and carbohydrate feedstocks by a fermentation process. Sophorolipid compositions derived from other fatty acid sources of different chain length and degree of unsaturation are included within the invention disclosed in this specification without departing from the scope and spirit of the invention.

### Synthesis of Hydrogenated Lactonic Sophorolipid (Compound Code 4)

Under a blanket of nitrogen in a 250 ml Parr bottle, a solution of lactonic sophorolipid mixture (5.00 g, 7.50 mmol in 75 ml 95% ethanol) was charged with 100 mg of 10 wt % Pd/C. The reactor was degassed and charged with 1 atm hydrogen. The reaction was allowed to run for 4 hours (the hydrogen pressure was periodically increased to 1 atm during this time). After 4 hours, the reaction mixture was filtered to remove the bulk of the Pd/C and the solution concentrated to dryness to afford white waxy crystals.

### Synthesis of ethyl 17-L[(2′-O-β-D glucopyranosyl-β-D-glucopyranosyl)oxy]-cis-9-octadecenoate 6′-acetate (compound code 13)

To a solution of ethyl ester derivative (compound code 7) (325.4 mg, 0.5 mmol) prepared from sophorolipid mixture was added vinyl acetate (0.231 L, 2.5 mmol) in dry THF (5 mL) and Novozyme 435 (100 mg). The mixture was stirred at 40° C. for 4 hours under nitrogen atmosphere and the enzyme filtered out and washed with THF. The product was evaporated to dryness and purified by flash chromatography (silica gel, 1:10 MeOH/CHCl₃).

### Synthesis of 2-dimethylaminoethyl 17-L[(2′-O-β-D glucopyranosyl-β-D-glucopyranosyl)oxy]-cis-9-octadec-9-enamide (compound code 15)

To 700 mg (1.1 mmol) sophorolipid methyl ester (compound code 6) was added N′,N′-dimethylethylenediamine (950 mg, 11 mmol, 10 equiv.). The reaction mixture was heated to 70° C. for 12 hours and concentrated to dryness (excess N′,N′-dimethylethylenediamine was removed in this step). The product was purified by flash chromatography (1:9 MeOH/CHCl₃).

### Synthesis of 2-trimethylethanaminium 17-L[(2′-O-β-D-glucopyranosyl-β-D-glucopyranosyl)oxy]-cis-9-octadec-9-enamide iodide (compound code 16)

To 300 mg (0.43 mmol) sophorolipid N′,N′-dimethylethylamide (SL-AM-3) was added methyl iodide (0.037 mL, 0.60 mmol, 1.4 equiv) in 2 mL methanol. The reaction mixture was heated to reflux temperature for 24 hours and concentrated in vacuo. The product was purified by flash chromatography (1:9 MeOH/CHCl₃).

Results and Discussion

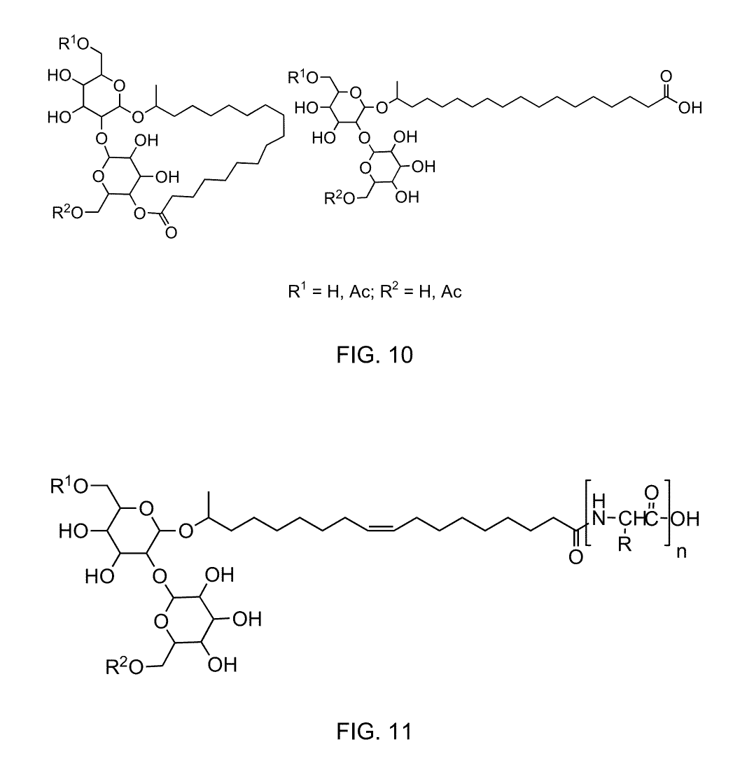

One class of sophorolipid derivatives includes lactonic and acidic sophorolipids in which the C═C bond has been reduced by hydrogen in the presence of a catalyst (FIG. 10). An exemplary reaction, applied to the conversion of lactonic sophorolipid (compound code 2) to hydrogenated lactonic sophorolipid (compound code 5), is shown below. It is contemplated that all of the derivatives (ester, amide, acetylated sophorose, inter alia) could be synthesized in a hydrogenated form. A related class of modifications at the C═C double bond include dihydroxylation carried out, for example, using the Sharpless asymmetric dihydroxylation catalyst. Other routes familiar to one skilled in the art would include acid catalyzed hydrolysis of the corresponding epoxide that could be generated using m-chloroperbenzoic acid or the Jacobsen epoxidation catalysts. A related class of modifications at the C═C double bond include the thiol-ene reaction that would lead to the formation of the corresponding thioether.

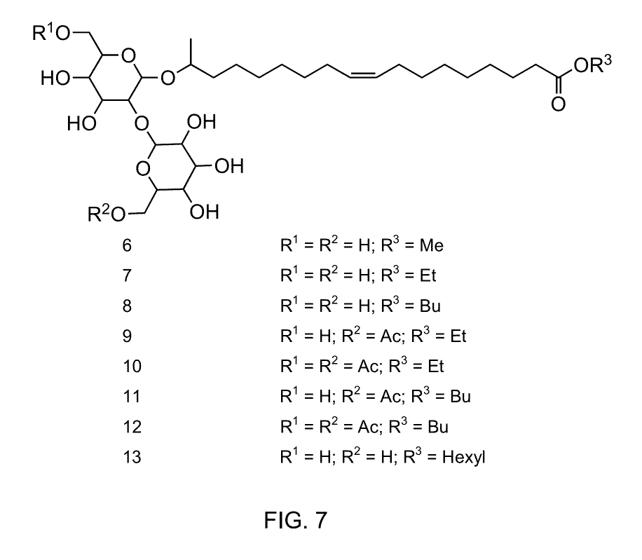

A second class of sophorolipid derivatives includes esterified ring-opened sophorolipids. Esterification of sophorolipids is achieved by alcoholysis of natural sophorolipid mixtures. Esters of varying chain lengths and with varying degrees of branching and containing a variety of heteroatoms are included in this invention (FIG. 7). Moreover, methods are already disclosed in the literature that describe selective acetylation of SLs at the 6′- and/or 6″-hydroxy sophorose groups. Therefore one skilled in the art will recognize that many variants may be generated by permutations of the ester functional group and sophorose acetyl groups.

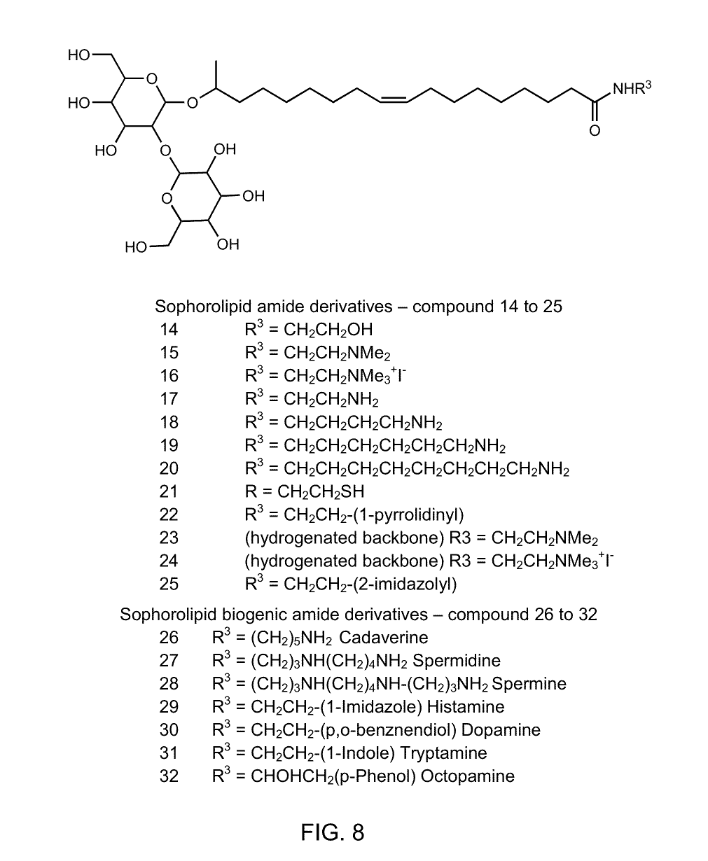

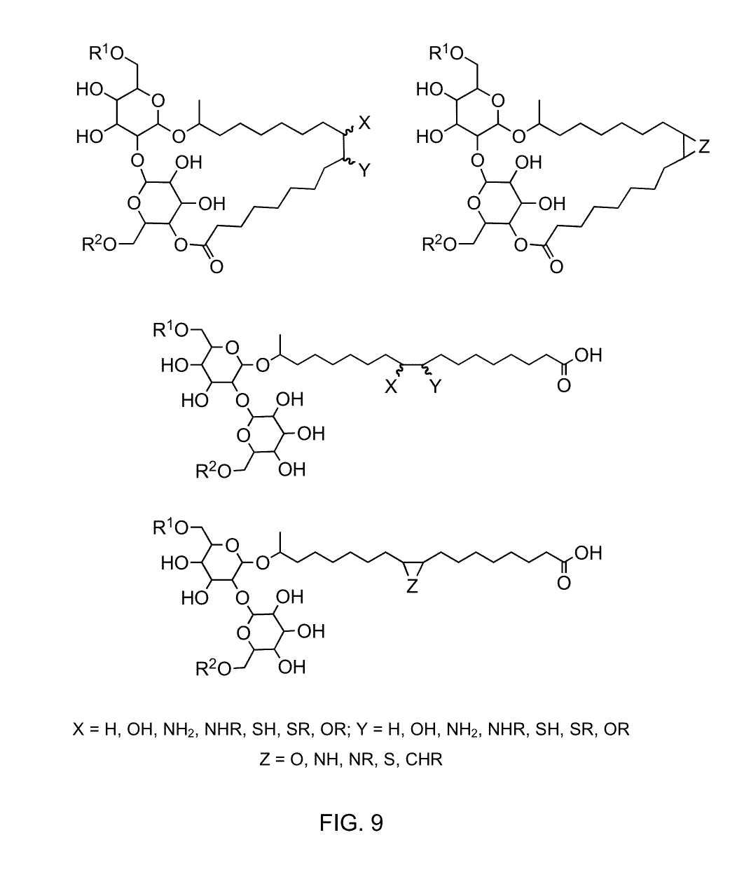

A third class of sophorolipid derivatives includes amides of acidic sophorolipids. Representative examples of sophorolipid amide derivatives are shown in FIG. 8. In the exemplary reaction shown, sophorolipid amides can be synthesized from the sophorolipid methyl ester derivative (compound code 6) by treatment with an amine at elevated temperature. It is contemplated that a variety of amines, diamines, triamines of differing chain lengths containing aliphatic, olefinic, acetylenic, and aromatic substituents can be used to synthesize the corresponding amide derivatives. Additionally, inclusive of this invention are amides derived from biogenic amines including, but not limited to, 4-aminosalicylic acid, 5-aminosalicylic acid, octopamine, 3-hydroxytyramine, phenethylamine, tryptamine, histamine, spermine, spermidine, 1,5-diaminopentane. Additionally, inclusive of this invention are amides bearing at the sophorose head group ionic moieties such as sulfate, sulfonate, phosphate, carboxylate and quarternary ammonium salts that result in cationic or anionic charged head groups. Additionally, it is contemplated that a variety of substituted amino-containing compounds can be used as a platform to expand the family of sophorolipid amides and that amino acids and polypeptides of varying chain lengths and composition can be incorporated (FIG. 11).

A fourth class of sophorolipids includes ammonium salts derived from SL-amides with N′,N′-dimethylamino moieties. An exemplary reaction is conversion of the sophorolipid N′,N′-dimethylethylamide derivative into the corresponding ammonium salt by treatment with methyl iodide at elevated temperature. It is contemplated that the quaternary ammonium salt may be prepared from alkyl halides of varying chain length as well as βββ-diiodoalkanes, leading to the formation of a wide array of sophorolipid structures.

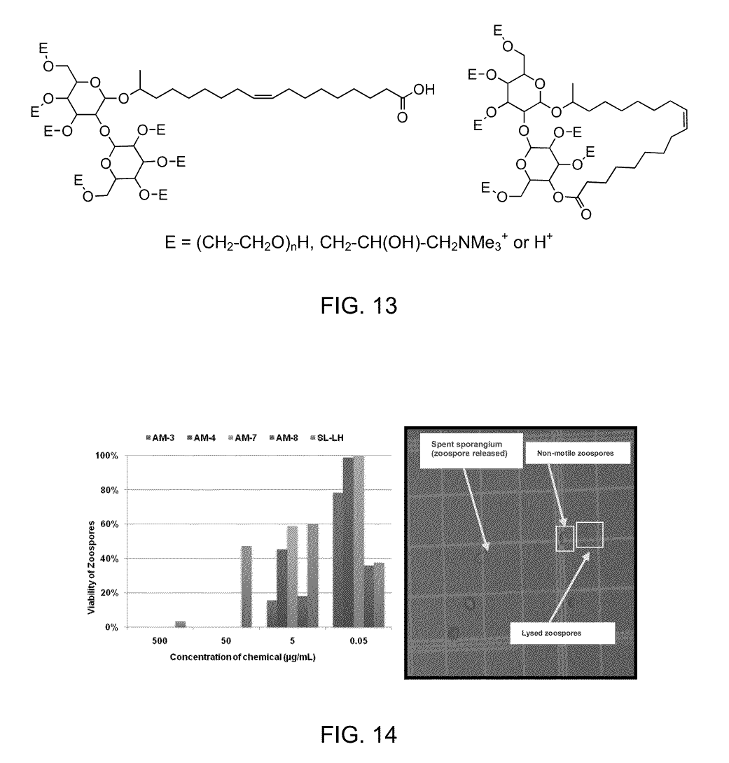

A fifth class of sophorolipids include those modified at the sophorose 6′ or 6″ positions by, inter alia, an activated acyl molecule such as the vinyl ester or alkyl ester of propionic acid catalyzed by an enzyme catalyst such as a lipase in conjunction with one or more of the modifications described herein. In one exemplary prior art reaction, the unsubstituted open-chain acidic sophorolipid is acetylated at the sophorose 6′-hydroxyl position. It is contemplated that carbonyl compounds of varying chain lengths and degrees of branching can be incorporated in the present invention and that a variety of carbonyl-containing functional groups can be incorporated including succinate, malate and citrate. Additionally, it is contemplated that esters of amino acids and oligopeptides can be incorporated at the 6′ and/or 6″ positions of the sophorose ring. Finally, it is contemplated that the 6′ and/or 6″ positions of the sophorose ring may be alkylated (FIG. 13) by ethylene oxide or a substituted alkylene oxide such as 2,3-epoxypropyl-1,1,1-trimethylammonium chloride (Quab151) or related electrophiles. Such substitutions will likely occur at the primary (1°) 6′ and/or 6″ positions but may also occur at the secondary (2°) sophorose ring hydroxyl groups to generate mixtures of sophorolipid derivatives.

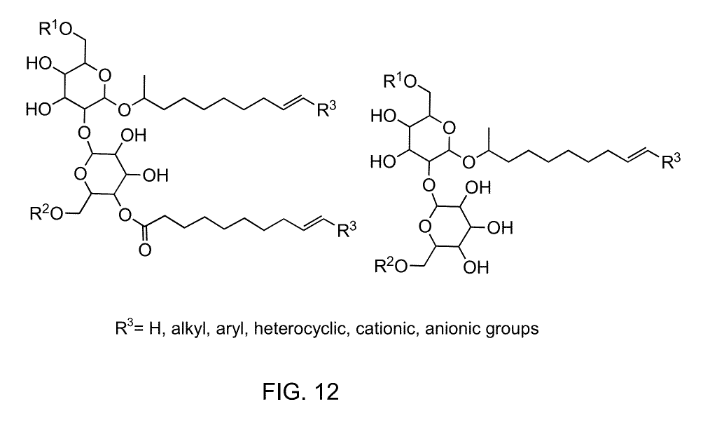

A sixth class of sophorolipids include those formed from transalkylidenation of carbon-carbon double bonds (C═C) within R⁴ (FIG. 4) of lactonic or open-chain acidic sophorolipids (FIG. 12). Novel compounds in this class include alkenes with linear or branched alkyl substituents. Additional novel compounds contemplated in this class are those in which the olefinic carbon generated from a transalkylidenation of carbon-carbon double bonds (C═C) within R⁴ is substituted with groups that contain an aryl, heterocyclic, cationic, anionic or neutral moieties (FIG. 12, R³=H, alkyl, aryl, alkanamide, heterocycle). The transalkylidenation chemistries described herein can be applied to carbon-carbon double bonds (C═C) within R⁴ for both the open chain and lactonic SL forms (see FIG. 4). Furthermore, combinations of metathesis (performed on either the lactonic or open chain SL) and chemical modification can be anticipated. As one illustrative example, the cross metathesis of lactonic sophorolipid with vinyl acrylate will produce a diester wherein each of the ester groups can be converted into the corresponding amide derivative (Scheme 2).

TABLE 2
Sophorolipid derivatives and pure sophorolipid components of the natural
mixture used in bacterial and fungal plant pathogen assays. The hydroxylated fatty acid
of the natural mixture is predominantly 17-hydroxyoleic acid. However, other fatty acid
constituents with variations in chain length and unsaturation may also be present.

| Class/Structure | Substituent(s) | Code |
|---|---|---|
| Natural Sophorolipids | Mixture of 2 and 3 | 1 |
| Lactonic Sophorolipids (mixture) 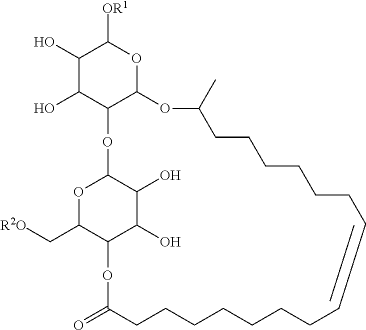 | R¹ = R² = OAc R¹ = H; R² = OAc R¹ = OAc; R² = H R¹ = R² = H | 2 |
| Acidic Sophorolipids (mixture) 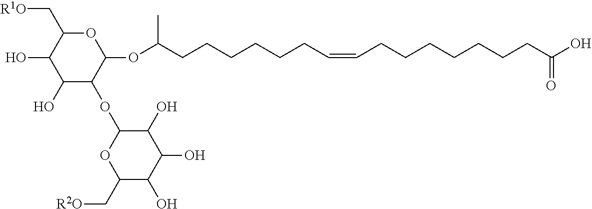 | R¹ = R² = OAc R¹ = H; R² = OAc R¹ = OAc; R² = H R¹ = R² = H | 3 |
| Hydrogenated natural sophorolipids | Mixture | 4 |
| Hydrogenated lactonic sophorolipids | R¹ = R² = Ac | 5 |
| Sophorolipid Esters 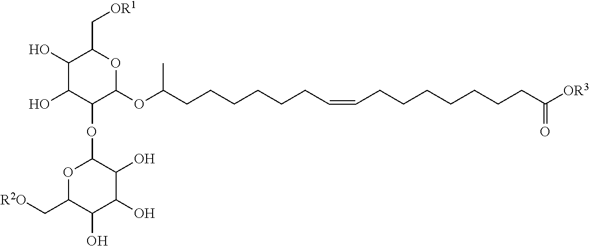 | R¹ = R² = H; R³ = Me R¹ = R² = H; R³ = Et R¹ = R² = H; R³ = Bu R¹ = Ac; R² = H; R³ = Et R¹ = R² = Ac; R³ = Et R¹ = H; R² = Ac; R³ = Bu R¹ = R² = Ac; R³ = Bu R¹ = H; R² = Ac; R³ = Et | 6 7 8 9 10 11 12 13 |
| Sophorolipid Amides 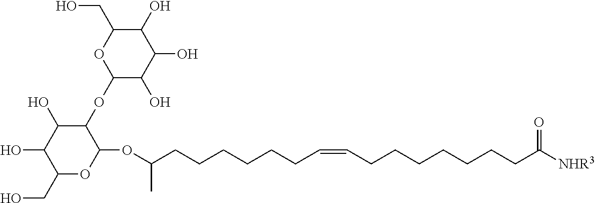 | R³ = CH₂CH₂OH R³ = CH₂CH₂NMe₂ R³ = CH₂CH₂NMe₃⁺ R³ = CH₂CH₂NH₂ R³ = (CH₂)₄NH₂ R³ = (CH₂)₆NH₂ R³ = (CH₂)₈NH₂ R³ = CH₂CH₂SH R³ = CH₂CH₂-(1-pyrrolidinyl) R³ = CH₂CH₂-(2-imidazolyl) | 14 15 16 17 18 19 20 21 22 25 |
| Hydrogenated sophorolipid amides 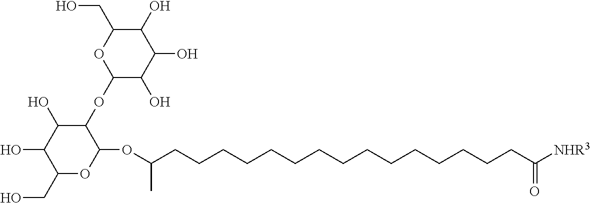 | R³ = CH₂CH₂NMe₂ R³ = CH₂CH₂NMe₃⁺ | 23 24 |
| Sophorolipid biogenic amides 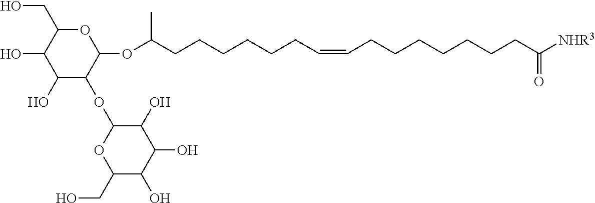 | R³ = (CH₂)₅NH₂ R³ = (CH₂)₃NH(CH₂)₄NH₂ R³ = (CH₂)₃NH(CH₂)₄NH—(CH₂)₃NH₂ R³ = CH₂CH₂-(1-Imidazole) R³ = CH₂CH₂-(p,o-benznendiol) R³ = CH₂CH₂-(1-Indole) R³ = CHOHCH₂(p-Phenol) | 26 27 28 29 30 31 32 |

### Representative Examples of Antibacterial and Antifungal Activity

### Example 1

### Antifungal Activity of Natural (Compound Code 1), Lactonic (Compound Code 2), Hydrogenated Lactonic (Compound Code 5) and Hydrogenated Natural (Compound Code 4) Sophorolipids

The hydrogenated lactonic sophorolipids have antifungal activity, which were confirmed by experiment and observations. Sophorolipid samples were dissolved in 5% ethanol solution to a final concentration of 10 mg/mL that was used as a stock solution. The stock solution (100 μL) was added into a 96 well microplate and serially diluted from 10 mg/mL to 0.0024 mg/mL using culture medium. After serial dilution, 80 μL of fresh culture medium and 20 μL of spore suspension were added to each well and the plates were incubated for 7 days. The minimum inhibitory concentration (MIC) was determined to measure antifungal activity of sophorolipid-derived compounds. MIC values for antifungal activity were determined by the absence of visible growth in the micro wells containing sophorolipid after 7 days of incubation. Compounds of compound codes (1) and (2) were active against four pathogens, whereas compounds of compound codes (5) and (3) were active against three and two pathogens respectively. In several cases, hydrogenated sophorolipids showed comparable or better inhibition to fungal growth versus natural sophorolipids. The results are shown in Table 3.

TABLE 3
Antifungal activity of natural (compound code 1), lactonic
(compound code 2), hydrogenated lactonic (compound code 5)
and hydrogenated natural (compound code 4) sophorolipids.

| | Compound codes | | | |
|---|---|---|---|---|
| | 1 | 2 | 5 | 4 |
| Pathogens | MIC (mg/mL) | | | |
| Alternaria tomatophilia | 2.5 | — | 2.5 | — |
| A. solani | 2.5 | — | — | — |
| A. alternata | 2.5 | 2.5 | 2.5 | — |
| Fusarim oxysporum | — | 2.5 | — | — |
| Botrytis cinerea | — | 2.5 | 0.6 | — |
| Phytophthora infestans | — | — | — | 2.5 |
| P. capsici | — | 0.6 | — | 0.6 |
| Ustilago maydis | — | — | — | — |
| Fusarium asiaticum | — | 2.5 | 0.6 | — |
| F. austroamericanum | 2.5 | 2.5 | 1.25 | 2.5 |
| F. cerealis | 2.5 | 2.5 | 2.5 | — |
| F. graminearum | — | 2.5 | 0.6 | — |
| Penicillium chrysogenum | 2.5 | — | — | — |
| P. digitatum | 2.5 | — | — | 2.5 |
| P. funiculosum | — | — | — | 2.5 |
| Aspergillus niger | — | 2.5 | — | — |
| Aureobasidium pullulans | — | | 2.5 | 2.5 |
| Chaetomium globosum | — | — | — | |

“—” means no activity.
MIC = Minimum Inhibitory Concentration.
Compound names
1 Natural sophorolipid
2 Lactonic sophorolipid
5 Hydrogenated lactonic sophorolipid
4 Hydrogenated sophorolipid mixture

### Example 2

### Antifungal Activity of Sophorolipid Ester Derivatives

The sophorolipid esters have antifungal activity, which was confirmed by experiment and observations. Sophorolipid samples were dissolved in 5% ethanol solution to a final concentration of 10 mg/mL and used as a stock solution. The stock solution (100 μL) was added into a 96 well microplate and serially diluted from 10 mg/mL to 0.0024 mg/mL using culture medium. After serial dilution, 80 μL of fresh culture medium and 20 μL of spore suspension were added to each well and the plates were incubated for 7 days. MIC values were determined to measure antifungal activity of this family of sophorolipid derivatives. MIC values for antifungal activity were determined by the absence of visible growth in the micro wells containing sophorolipid-derivatives after 7 days of incubation. These results show that methyl (compound code 6) and butyl esters (compound code 8) actively inhibited the growth of three pathogens while other esters (compound codes 9, 5, 6, and 8) are active against one of the pathogens. In several cases, sophorolipid esters showed comparable or better inhibition of fungal growth versus natural sophorolipids. The results are shown in Table 4.

TABLE 4
Antifungal activity of sophorolipid ester derivatives^{a}

| | Compound codes | | | | | | |
|---|---|---|---|---|---|---|---|
| Pathogens | 6 | 8 | 9 | 10 | 11 | 12 | 1 |
| | MIC (mg/mL) | | | | | | |
| Alternaria tomatophilia | — | 0.15 | — | — | — | — | 2.5 |
| A. solani | 2.5 | 1.25 | — | — | — | 1.25 | 2.5 |
| A. alternata | — | — | — | — | — | — | 2.5 |
| Fusarium oxysporum | 2.5 | — | — | — | — | — | — |
| Botyris cinerea | — | — | — | — | — | — | — |
| Phytophthora infestans | — | 1.25 | — | — | — | — | — |
| P. capsici | 1.25 | — | 0.6 | 0.6 | 0.6 | — | — |
| Ustilago maydis | — | — | — | | | — | — |

“—” means no activity.
MIC = Minimum Inhibitory Concentration.
^{a}Structures of sophorolipid ester derivatives are shown in FIG. 7 and Table 2.
Compound names
6 ring opened SL-methyl ester
8 ring opened SL-butyl ester
9 ring opened 6″-acetyl-SL-ethyl ester
10 ring opened 6′,6″-diacetyl-SL-ethyl ester
11 ring opened 6″-acetyl-SL-butyl ester
12 ring opened 6′,6″-diacetyl-SL-butyl ester
1 Natural sophorolipid mixture

### Example 3

### Antifungal Activity of Sophorolipid Amide Derivatives

The ring-opened SL-amide derivatives have antifungal activity, which was confirmed by experiment and observations. Sophorolipid samples were dissolved in 5% ethanol solution to a final concentration of 10 mg/mL and used as a stock solution. The stock solution (100 μL) was added into a 96 well microplate and serially diluted from 10 mg/mL to 0.0024 mg/mL using culture medium. After serial dilution, 80 μL of fresh culture medium and 20 μL of spore suspension were added to each well and the plates were incubated for 7 days. The MIC was determined to measure antifungal activity of the sophorolipid-derivatives. MIC values for antifungal activity were determined by absence of visible growth in micro wells containing sophorolipid derivatives after 7 days of incubation. Among all sophorolipids screened for antifungal activity, the family of amide derivatives shows high activity against four pathogens. The results are shown in Table 5.

TABLE 5
Antifungal activity of sophorolipid amide derivatives

| | Compound codes | | | | | | | | | | | | |
|---|---|---|---|---|---|---|---|---|---|---|---|---|---|
| Pathogens | 14 | 15 | 16 | 17 | 18 | 19 | 20 | 21 | 22 | 23 | 24 | 25 | 1 |
| | MIC (mg/mL) | | | | | | | | | | | | |
| Alternaria tomatophilia | 2.5 | 0.3 | 0.15 | 0.6 | 0.3 | 0.3 | 0.6 | — | — | 1.25 | 2.5 | 5 | 2.5 |
| A. solani | — | 0.15 | 0.6 | — | 1.25 | 0.31 | 0.31 | — | 2.5 | 1.25 | 2.5 | 2.5 | 2.5 |
| A. alternata | — | 1.25 | 1.25 | 1.25 | 1.25 | 1.25 | 1.25 | — | 2.5 | 2.5 | 2.5 | 10 | 2.5 |
| Botrytis cinerea | 2.5 | 0.6 | 0.6 | 0.6 | 0.6 | 0.6 | 0.6 | 1.25 | 2.5 | 5 | — | — | — |
| Phytophthora infestans | — | 5 | 5 | — | — | 10 | 10 | — | — | — | — | — | — |
| P. capsici | — | 10 | 10 | 1.25 | 1.25 | 0.6 | 0.6 | — | — | — | — | — | — |
| Ustilago maydis | — | — | 5 | 2.5 | — | 2.5 | 2.5 | — | — | 1.25 | 2.5 | 5 | — |
| Fusarium asiaticum | — | — | 0.6 | — | — | 2.5 | 2.5 | — | — | 1.25 | 2.5 | 5 | — |
| F. austroamericanum | — | 0.6 | 0.6 | — | — | 1.25 | 1.25 | — | — | — | — | — | — |
| F. cerealis | — | 0.6 | — | — | — | 1.25 | 1.25 | — | — | 2.5 | 5 | 5 | 2.5 |
| F. graminearum | — | 0.6 | 0.6 | — | — | 5 | 10 | — | — | — | 5 | 5 | 2.5 |
| F. oxysporum | — | — | — | — | — | 5 | 2.5 | — | — | 1.25 | 2.5 | 2.5 | — |
| Penicillium chrysogenum | — | — | 2.5 | — | — | 5 | 10 | — | — | — | — | — | 2.5 |
| P. digitatum | — | 0.3 | 0.3 | — | — | 0.6 | 0.6 | — | — | — | — | — | 2.5 |
| P. funiculosum | — | 2.5 | 2.5 | — | — | 1.25 | 2.5 | — | — | 5 | 2.5 | 2.5 | — |
| Aspergillus niger | — | 5 | 5 | — | — | 10 | 10 | — | — | — | 5 | — | — |
| Aureobasidium pullulans | — | 1.25 | 1.25 | — | — | 5 | 5 | — | — | — | 5 | — | — |
| Chaetomium globosum | — | — | — | — | — | 0.6 | 0.6 | — | — | 2.5 | 2.5 | 10 | — |
| Rhizoctonia solani | — | 1.0 | 1.0 | NT | NT | NT | NT | NT | NT | NT | NT | NT | — |
| Sclerotinia sclerotiorum | — | 1.0 | 1.0 | NT | NT | NT | NT | NT | NT | NT | NT | NT | — |

“—” means no activity.
MIC = Minimum Inhibitory Concentration.
NT = Not Tested.
Compound names
14 ring opened SL-2-ethanolamide
15 ring opened SL-dimethylaminoethylamide
16 ring opened SL-N,N,N-trimethylethanaminium amide
17 ring opened SL-2-aminoethylamide
18 ring opened SL-4-aminobutylamide
19 ring opened SL-6-aminohexylamide
20 ring opened SL-8-aminooctylamide
21 ring opened SL-2-thioethylamide
22 ring opened SL-2-(1-pyrrolidinyl)ethyl amide
23 hydrogenated ring opened SL-dimethylaminoethylamide
24 hydrogenated ing opened SL-trimethylethanaminium amide
25 ring opened SL-2-(2-imidazolyl)ethyl amide
1 Natural sophorolipid mixture

### Example 4

### Antifungal Activity of Sophorolipid Biogenic Amides

The ring-opened SL-biogenic amide derivatives (compound codes 26 to 32) have antifungal activity, which was confirmed by experiment and observations. Sophorolipid samples were dissolved in distilled water to a final concentration of 10 mg/mL and used as a stock solution. The stock solution (100 μL) was added into a 96 well microplate and serially diluted from 10 mg/mL to 0.0024 mg/mL using culture medium. After serial dilution, 80 μL of fresh culture medium and 20 μL of spore suspension were added to each well and the plates were incubated for 7 days. The MIC was determined to measure antifungal activity of the sophorolipid-derivatives. MIC values for antifungal activity were determined by absence of visible growth in micro wells containing sophorolipid derivatives after 7 days of incubation. Among the sophorolipids screened for antifungal activity, SL-spermine, SL-histamine and SL-dopamine derivatives shows high activity against 13, 16 and 15 pathogens, respectively. The results are shown in Table 6.

TABLE 6
Antifungal activity of sophorolipid biogenic amide derivatives

| | Compound codes | | | | | | |
|---|---|---|---|---|---|---|---|
| Pathogen | 26 | 27 | 28 | 29 | 30 | 31 | 1 |
| | MIC (mg/mL) | | | | | | |
| Alternaria tomatophilia | 0.15 | 1.25 | 0.15 | 5 | 0.3 | — | 2.5 |
| A. solani | 0.3 | 0.3 | 0.15 | 2.5 | 0.3 | — | 2.5 |
| A. alternata | 2.5 | 10 | 0.6 | 5 | 5 | — | 2.5 |
| Fusarium oxysporum | — | — | 5 | 10 | 10 | — | — |
| Botrytis cinerea | 2.5 | 10 | 2.5 | 2.5 | 1.25 | 10 | — |
| Phytophthora infestans | — | — | — | — | — | — | — |
| Ustilago maydis | — | — | 10 | 10 | — | — | — |
| Phytophthora capsici | — | — | — | — | — | — | — |
| Fusarium asiaticum | — | — | 2.5 | 5 | 5 | — | — |
| F. austroamericana | — | — | 0.6 | 10 | 5 | — | — |
| F. cerealis | — | — | 1.25 | 10 | 5 | — | 2.5 |
| F. graminearum | 5 | — | 0.3 | 5 | 5 | — | 2.5 |
| Penicillium | 5 | — | 0.6 | 10 | 10 | — | 2.5 |
| chyrsogenum | | | | | | | |
| P. digitatum | — | — | — | 2.5 | 0.6 | 10 | 2.5 |
| P. funiculosum | 2.5 | 5 | 1.25 | 5 | 2.5 | 10 | — |
| Asperigillus niger | — | — | 5 | 10 | 2.5 | — | — |
| Aureobasidium | — | — | — | 2.5 | 2.5 | 10 | — |
| pullulans | | | | | | | |
| Chaetomium globosum | — | — | — | 2.5 | 2.5 | — | — |

“—” means no activity.
MIC = Minimum Inhibitory Concentration.
Compound names
26 ring opened SL-cadaverine
27 ring opened SL-spermidine
28 ring opened SL-spermine
29 ring opened SL-histamine
30 ring opened SL-dopamine
31 ring opened SL-trytamine
32 ring opened SL-octopamine

### Example 5

### Antifungal Activity of SL Derivatives Against Downy (Plasmopara viticola) and Powdery Mildew (Erysiphe necator) Pathogens

Antifungal activity of SL derivatives against downy and powdery mildew pathogens were test on 1% (agar, v/v) water agar plates. Fresh grapes leaves were surface sprayed with 0.5 mL solutions of SL compounds (in water or in 5% ethanol) and air-dried for 30 minutes by leaving the lids off leaf containing Petri dishes in the hood before inoculating the pathogen. Grape leaves were inoculated with: i) powdery mildew (˜5000 spores) using the Preval sprayer and air-dried for 30 min, ii) downy mildew (˜5000 spores) was inoculated using the spray bottle without drying. For powdery mildew, after incubations at 20° C. for a 12 hours photoperiod, leaves were observed at 10, 14, and 21 days post-inoculation (dpi) to determine the percentage of leaf area covered on a 0-10 scale (0=0%, 10=100%). Downy mildew was rated at 6 dpi using the same scale and incubation conditions. The results are shown in Table 7.

Zoospore lysis activity: an in vitro assay was also conducted in the absence of the host leaves to test the effect of each chemical on zoospore viability. Zoosporangia were harvested from above downy mildew pathogen and incubated in water for 30 min for germination of swimming zoospores. The zoospore suspensions were then incubated for 5 min with a dilution series of each compound or a water control. To quantify viability, two 10 μL droplets were then placed on a hemocytometer, and the number of swimming zoospores was counted in five grids per droplet. All data is presented as the percent of the average disease or viability for that treatment relative to the average untreated control.

TABLE 7
Antifungal activity of SL amide derivatives on Downy (Plasmopara
viticola) and powdery mildew (Erysiphe necator) pathogens.

| | Compound codes | | | | |
|---|---|---|---|---|---|
| | 15 | 16 | 19 | 20 | 1 |
| Pathogen | MIC mg/mL | | | | |
| Plasmopara viticola | 5 | 5 | — | — | — |
| (Downy mildew) | | | | | |
| Erysiphe necator | 5 | 5 | 5 | 5 | — |
| (Powdery mildew) | | | | | |

“—” means no activity.
Compound names
15 ring-opened SL-dimethylaminoethylamide
16 ring-opened SL-N,N,N-trimethylethanaminium amide
19 ring-opened SL-6-aminohexylamide
20 ring-opened SL-8-aminooctylamide
1 Natural sophorolipid mixture

Results of zoospore lysis by SL-derivatives showed that viability was completely lost when spores were treated with compounds codes 16, 19, and 20 at concentrations of 500-50 μg/ml. Based on observations of intact dead zoospores and apparently lysed zoospores, preliminary evidence suggests that compound codes 16, 19, and 20 efficiently lyse zoospores (FIG. 14), while compound 15 is lethal with much less lysis.

### Example 6

### Antifungal Activity of SL Derivatives on Wheat Stem Rust Pathogen, Puccinia graminis f. sp. tritici in Green House System

Five seeds of the highly susceptible wheat variety ‘Baart’ were planted into 10 cm plastic pots containing a mixture of field soil and commercial greenhouse potting mix (1:1, vol:vol). These were grown in the greenhouse under supplemental lighting (16 h/day) at a temperature regime of 25° C./20° C. (day:night). Plants were watered and fertilized as necessary to maintain optimal growth conditions. At 14 days after planting (DAP), SL-derivatives were applied at two different application rates (1 or 10 mg/mL) in the appropriate carrier solvent (5% ethanol/water) using a DeVilbiss atomizer pressurized to ˜100 kPa. Three replicate pots were treated and the foliage was allowed to dry before returning to the greenhouse.

At ˜24 hours after application of the compounds, urediniospores of Puccinia graminis f. sp. tritici (wheat stem rust, race QFCS) were applied in a suspension of Soltrol 170 using the aforementioned atomizer. The urediniospores had previously been kept at −80° C. and were heat-shocked for 5 min at 42° C. prior to being suspended in the oil. Following inoculation, the plants were placed in front of a fan for 15 min to expedite oil evaporation. Once completed, plants were placed into an incubation chamber and incubated at 100% relative humidity at 18° C. for 12 hours in the dark to induce spore germination and aspersorium formation. After the initial incubation period, plants were exposed to light, the temperature increased, and the dew was allowed to slowly evaporate from plants to stimulate the completion of the infection process. The plants were then returned to the greenhouse and maintained at the aforementioned conditions. At 14 days after inoculation, percent leaf area as pustules was visually rated on a minimum of three leaves per pot for all replicate pots. The results are shown in Table 8.

TABLE 8
Effect of SL derivatives on wheat stem rust pathogen

| | | % of reduction in |
|---|---|---|
| Compound | Concentration of SL | infection/pathogen |
| Code | compound (mg/mL) | growth |
| Control | Distilled water | — |
| Control- | 5.0% Ethanol (in water) | — |
| Ethanol | | |
| 15 | 10 | 65 |
| 16 | 10 | 54 |
| 7 | 10 | 48 |
| 1 | 10 | 57 |

“—” means no activity
Compound names
15 ring-opened SL-dimethylaminoethylamide
16 ring-opened SL-trimethylethanaminium amide
7 ring-opened SL-2-aminoethanesulfonic acid
1 Natural sophorolipid mixture

With the exception of compound code 7, all SL-compounds applied at a concentration of 10 mg/mL significantly reduced symptom development compared to the corresponding control (Table 6). Treatments with compound codes 15, 16, and 1 at 10 mg/mL concentration inhibited symptom development by 65%, 54%, and 57%, respectively. In summary, treatments with compound codes 15, 16, and 1 all limited symptom development of wheat stem rust.

### Example 7

### Antifungal Activity of SL Derivatives on Wheat Stripe Rust, Rice Blast, Sheath Blight, Spinach Downy Mildew and White Rust Pathogens in Green House System

Wheat, rice and spinach are major food and vegetable crops. Wheat stripe rust, rice blast, sheath blight, spinach downy mildew and white rust are economically important diseases on these crops. Pathogens used in this experiment are listed in Table 9. The plants were grown in greenhouse and inoculated at age 2-weeks except for studies with spinach white rust where plants were inoculated at age 4-weeks. The plants were treated with the test materials (sophorolipid compounds, positive/negative controls) and, after 24 h they were inoculated with the pathogen. Positive controls consisted of plants treated only with water. Inoculated plants were scored 1-2 weeks after inoculation for either disease incidence or severity depending on the test.

TABLE 9
Pathogens used for screening of SL derivatives against wheat stripe rust,
rice blast, sheath blight, spinach downy mildew and white rust

| | | Cultivar | Pathogen strain |
|---|---|---|---|
| Plant disease | Pathogen | tested | used |
| Spinach downy | Peronospora farinosa f. sp. | Viroflay | UA0510C |
| mildew | Spinaciae | | |
| Spinach white rust | Albugo occidentalis | Viroflay | TX isolate |
| Wheat stripe rust | Puccinia striiformis f. sp. | FL 302 | AR-10-01 |
| | Tritici | | |
| Rice blast | Magnaporthe oryzae | M204 | 49D (IB49) |
| Rice sheath blight | Rhizoctonia solani | Lemont | VC11 (AG1-1A) |

The antimicrobial activity of compound codes 15, 16, 19, and 20 presented in Table 10 shows that each showed high activity (between 79 and 95% reduction in infection) with all 5 of the pathogens tested at 10 mg/mL concentration. Derivative compound code 5 also showed good activity (75-95% reduction in infection) with four of the five pathogens studied.

TABLE 10
Antifungal activities of SL-derivatives against wheat stripe rust, rice
blast, sheath blight, spinach downy mildew and white rust pathogens in
green house system.

| | Concen- | % of reduction in infection/pathogen growth | | | | |
|---|---|---|---|---|---|---|
| Com- | tration | Spinach | Spinach | Wheat | | Rice |
| pound | of com- | downy | white | stripe | Rice | sheath |
| Codes | pound | mildew | rust | rust | Blast | blight |
| Water | | 0 | 0 | 0 | 0 | 0 |
| 15 | 10 mg/mL | 86 | 75 | 90 | 95 | 75 |
| 16 | 10 mg/mL | 86 | 90 | 90 | 95 | 85 |
| 19 | 10 mg/mL | 83 | 90 | 90 | 95 | 85 |
| 20 | 10 mg/mL | 79 | 90 | 90 | 95 | 85 |
| 5 | 10 mg/mL | 95 | 75 | 50 | 75 | 75 |

Compound names
15 ring-opened SL-dimethylaminoethylamide
16 ring-opened SL-N,N,N-trimethylethanaminium amide
19 ring-opened SL-6-aminohexylamide
20 ring-opened SL-8-aminooctylamide
5 Hydrogenated lactonic SL

### Example 8

### Antibacterial Activity of SL Derivatives on Plant Pathogenic Bacteria

Bacterial infections in plants are much like the symptoms in fungal plant disease. Examples are leaf spots, blights, wilts, scabs, cankers and soft rots of roots, storage organs and fruit, and overgrowth. To determine the antibacterial activity of SL-derivatives, 7 different plant pathogenic bacteria were used (Table 11). Sophorolipid samples were dissolved in 5% ethanol solution to a final concentration of 10 mg/mL that was used as a stock solution. The stock solution (100 μL) was added into a 96 well microplate and serially diluted from 10 mg/mL to 0.0024 mg/mL using culture medium. After serial dilution, 80 μL of fresh culture medium and 20 μL of 24 hour grown bacterial culture were added to each well and the plates were incubated for 24 h at 37° C. Antibacterial activity was determined by measuring the optical density (OD) of micro wells containing sophorolipid and bacterial culture at 540 nm in a spectrophotometer. A control was maintained for each bacterial culture without adding sophorolipids into the culture medium. The difference in OD between SL added wells and control was calculated and converted into % growth inhibition. The formula used for the calculation of %-growth inhibition is: [Control OD−OD of SL added wells/Control OD]×100. Among all sophorolipids screened for antibacterial activity, the family of amide derivatives shows high activity against all pathogens tested. The results are shown in Table 11.

TABLE 11
Antibacterial activity of SL amide derivatives on plant pathogenic bacteria

| | Compound codes | | | |
|---|---|---|---|---|
| | 1 | 15 | 16 | 19 |
| | MIC | MIC | MIC | MIC |
| | 10 mg/mL | 10 mg/mL | 10 mg/mL | 2.5 mg/mL |
| Pathogen | % of growth inhibition | | | |
| Pseudomonas syringae | — | 85 ± 06 | 78 ± 05 | 93 ± 06 |
| Xanthomonas campestris | 37 ± 03 | 75 ± 05 | 79 ± 06 | 86 ± 03 |
| Pectobacterium | 45 ± 04 | 72 ± 05 | 73 ± 06 | 62 ± 04 |
| carotovorum | | | | |
| Acidovorax carotovorum | 29 ± 06 | 63 ± 03 | 66 ± 03 | 91 ± 04 |
| Ralstonia solanacearum | 22 ± 04 | 68 ± 02 | 63 ± 04 | 53 ± 04 |
| Erwinia amylovora | 25 ± 05 | 69 ± 05 | 73 ± 03 | 61 ± 05 |
| Pseudomonas cichorii | — | 75 ± 03 | 74 ± 02 | 68 ± 05 |

“—” means no activity.
Compound names
1 Natural sophorolipid mixture
15 ring-opened SL-dimethylaminoethylamide
16 ring-opened SL-N,N,N-trimethylethanaminium amide
19 ring-opened SL-6-aminohexylamide

### Example 9

### Antibacterial Activity of Sophorolipid Biogenic Amides

Antibacterial activity of sophorolipid biogenic amides was tested using the micro-plate method as described in Example 8. Compound codes 28, 29 and 30 show the highest antibacterial activity than other SL-biogenic amides derivatives (Table 12).

TABLE 12
Antibacterial activity of sophorolipid biogenic amide derivatives

| | Compound codes | | | | | |
|---|---|---|---|---|---|---|
| Pathogen | 26 | 27 | 28 | 29 | 30 | 31 |
| | MIC 10 mg/mL | | | | | |
| | % growth inhibition | | | | | |
| Pseudomonas syringae | 45 ± 2 | 45 ± 4 | 81 ± 2 | 62 ± 8 | 77 ± 2 | 39 ± 5 |
| Xanthomonas campestris | 47 ± 4 | 47 ± 6 | 67 ± 4 | 63 ± 7 | 77 ± 2 | 63 ± 8 |
| Pectobacterium carotovorum | 42 ± 6 | 36 ± 2 | 81 ± 5 | 60 ± 8 | 52 ± 4 | 56 ± 2 |
| Acidovorax carotovorum | 51 ± 3 | 51 ± 3 | 83 ± 6 | 62 ± 4 | 77 ± 4 | 45 ± 6 |
| Ralstonia solanacearum | 51 ± 4 | 44 ± 2 | 80 ± 8 | 63 ± 5 | 75 ± 2 | 59 ± 9 |
| Erwinia amylovora | 43 ± 2 | 40 ± 5 | 83 ± 2 | 64 ± 4 | 75 ± 6 | 66 ± 6 |
| Pseudomonas cichorii | 47 | 38 ± 6 | 82 | 58 ± 3 | 74 ± 4 | 47 ± 4 |

MIC = Minimum Inhibitory Concentration
Compound names
26 R³ = (CH₂)₅NH₂ Cadaverine
27 R³ = (CH₂)₃NH(CH₂)₄NH₂ Spermidine
28 R³ = (CH₂)₃NH(CH₂)₄NH—(CH₂)₃NH₂ Spermine
29 R³ = CH₂CH₂-(1-Imidazole) Histamine
30 R³ = CH₂CH₂-(p,o-benznendiol) Dopamine
31 R³ = CH₂CH₂-(1-Indole) Tryptamine

### Example 10

### Formulation of Sophorolipid Derivatives

In the process of fungicidal or bactericidal pesticide development, formulation a plays major role by enhancing the performance of the active ingredients. Sophorolipid derivatives developed in this invention showed promising antimicrobial activity against plant fungal and bacterial pathogens. To further investigate the antimicrobial activity of sophorolipid derivatives, formulation of sophorolipid derivatives was performed by dissolving the sophorolipid derivatives (compound codes 1 to 32) (˜10 mg/mL or required quantity based on the assay) in 5% (w/v) polypropylene glycol and 5% (w/v) tween 20. Polypropylene glycol and tween 20 was used in antimicrobial formulation and improved the performance of active ingredients.

### Example 11

### Antifungal Activity of Formulated Lactonic Sophorolipid and Sophorolipid Esters

Antifungal activity of formulated lactonic sophorolipid and sophorolipid esters revealed that formulation has increased the broad spectrum activity (active against more number of pathogens) and decreased the MIC values of the formulated compounds than the unformulated compounds (Table 13).

TABLE 13
Antifungal activity of formulated lactonic sophorolipid and
sophorolipid esters

| | Compound codes | | | | |
|---|---|---|---|---|---|
| | 2 | 6 | 7 | 8 | 1 |
| Pathogen | MIC (mg/mL) | | | | |
| Alternaria tomatophilia | 10 | 10 | 5 | 1.25 | 2.5 |
| A. solani | 10 | 1.25 | 2.5 | 0.6 | 2.5 |
| A. alternata | 1.25 | — | 10 | 10 | 2.5 |
| Fusarium oxysporum | 10 | 2.5 | 10 | 5 | — |
| Botrytis cinerea | 10 | 10 | 1.25 | 10 | — |
| Phytophthora infestans | — | — | — | — | — |
| Ustilago maydis | 10 | — | 2.5 | 1.25 | — |
| Phytophthora capsici | 0.3 | — | — | 1.25 | — |
| Fusarium asiaticum | 10 | 2.5 | 2.5 | 5 | — |
| F. austroamericana | 1.25 | 10 | 5 | 0.6 | — |
| F. cerealis | — | 5 | 10 | — | 2.5 |
| F. graminearum | 10 | 5 | 10 | 5 | 2.5 |
| Penicillium chrysogenum | 1.25 | 10 | 10 | 10 | 2.5 |
| P. digitatum | 1.25 | 1.25 | 5 | 1.25 | 2.5 |
| P. funiculosum | — | 10 | 10 | 10 | — |
| Aspergillus niger | — | — | — | — | — |
| Aureobasidium pullulans | 2.5 | 10 | — | 10 | — |
| Chaetomium globosum | 5 | 10 | 5 | 2.5 | — |

“—” means no activity.
MIC = Minimum Inhibitory Concentration
Compound names
2 Lactonic sophorolipid
6 ring opened SL-methyl ester
7 ring-opened SL-2-aminoethanesulfonic acid
8 ring opened SL-butyl ester
1 Natural sophorolipid mixture

### Example 12

### Antifungal Activity of Formulated Sophorolipid Amide Derivatives

Sophorolipid amides derivatives of compound codes 15, 16, 19, and 20 were selected for formulation based on their antifungal activity results observed without formulation. After formulation the compounds become very active in terms of broad spectrum activity and 2 to 10 times reduction in their MIC values (Table 14).

TABLE 14
Antifungal activity of formulated lead sophorolipid amides

| | Compound codes | | | | |
|---|---|---|---|---|---|
| | 15 | 16 | 19 | 20 | 1 |
| Pathogen | MIC (mg/mL) | | | | |
| Alternaria tomatophilia | 0.15 | 0.15 | 0.3 | 0.07 | 2.5 |
| A. solani | 0.15 | 0.3 | 0.3 | 0.07 | 2.5 |
| A. alternata | 1.25 | 0.6 | 0.6 | 0.6 | 2.5 |
| Fusarium oxysporum | 10 | 5 | 2.5 | 2.5 | — |
| Botrytis cinerea | 0.15 | 1.25 | 0.6 | 0.03 | — |
| Phytophthora infestans | 1.25 | 5 | 5 | 5 | — |
| Ustilago maydis | 10 | 5 | 2.5 | 5 | — |
| Phytophthora capsici | 5 | 10 | 0.6 | 1.25 | — |
| Fusarium asiaticum | — | 0.6 | 2.5 | 2.5 | — |
| F. austroamericana | 1.25 | 1.25 | 1.25 | 1.25 | — |
| F. cerealis | 0.07 | — | 1.25 | 0.3 | 2.5 |
| F. graminearum | 0.6 | 1.25 | 5 | 5 | 2.5 |
| Penicillium chrysogenum | 2.5 | 1.25 | 5 | 2.5 | 2.5 |
| P. digitatum | 0.15 | 0.6 | 1.25 | 1.25 | 2.5 |
| P. funiculosum | 1.25 | 2.5 | 1.25 | 0.6 | — |
| Aspergillus niger | 5 | 5 | 10 | 10 | — |
| Aureobasidium pullulans | 1.25 | 1.25 | 2.5 | 1.25 | — |
| Chaetomium globosum | 5 | 5 | 1.25 | 0.6 | — |

“—” means no activity.
MIC = Minimum Inhibitory Concentration
Compound names
15 ring-opened SL-dimethylaminoethylamide
16 ring-opened SL-N,N,N-trimethylethanaminium amide
19 ring-opened SL-6-aminohexylamide
20 ring-opened SL-8-aminooctylamide
1 Natural sophorolipid mixture

### Example 13

### Antifungal Activity of Sophorolipid Biogenic Amide Derivatives

Sophorolipid biogenic amides derivatives of compound codes 28 and 30 were selected for formulation based on their antifungal activity results observed without formulation. After formulation the compounds become very active in terms of broad spectrum activity, example, compound code 28 was active against 13 pathogens before formulation and become active against 16 pathogens after formulation. For both the compounds a 2 to 10 times reduction in their MIC values were observed (Table 15).

TABLE 15
Antifungal activity of formulated lead biogenic amide compounds

| | 28 | 30 | 1 |
|---|---|---|---|
| Pathogen | MIC (mg/mL) | | |
| Alternaria tomatophilia | 0.15 | 0.3 | 2.5 |
| A. solani | 0.15 | 0.3 | 2.5 |
| A. alternata | 0.6 | 2.5 | 2.5 |
| Fusarium oxysporum | 1.25 | 10 | — |
| Botrytis cinerea | 0.3 | 1.25 | — |
| Phytophthora infestans | — | — | — |
| Ustilago maydis | 10 | — | — |
| Phytophthora capsici | — | — | — |
| Fusarium asiaticum | 2.5 | 2.5 | — |
| F. austroamericana | 1.25 | 2.5 | — |
| F. cerealis | 0.6 | 2.5 | 2.5 |
| F. graminearum | 1.25 | 5 | 2.5 |
| Penicillium chrysogenum | 1.25 | 10 | 2.5 |
| P. digitatum | 10 | 1.25 | 2.5 |
| P. funiculosum | 1.25 | 1.25 | — |
| Aspergillus niger | 5 | 1.25 | — |
| Aureobasidium pullulans | 5 | 1.25 | — |
| Chaetomium globosum | 1.25 | 1.25 | — |

“—” means no activity.
MIC = Minimum Inhibitory Concentration
Compound names
28 R³ = (CH₂)₃NH(CH₂)₄NH—(CH₂)₃NH₂ Spermine
30 R³ = CH₂CH₂-(p,o-benznendiol) Dopamine
1 Natural sophorolipid mixture

This demonstrates that by using newly developed sophorolipid derivative compositions of matter that are hereby incorporated within this invention, enhanced activity relative to the natural sophorolipid mixture against plant pathogenic organisms was achieved. It is understood that modified sophorolipid analogs can be used in pure form, admixed with one or more derivatives, admixed with one or more natural sophorolipids. Furthermore, two or more modifications described herein that are performed at different sites of the SL-molecule can be combined to create many permutations of the derivatives described herein. Examples would be derivatives that are modified by: i) hydrogenation of the carbon-carbon double bond and amidation at the carboxylate group, ii) transalkylidination of the SL-lipid carbon-carbon double bond by reaction with methyl acrylate followed by amidation at the formed methyl ester moiety, iii) amidation at the carboxylate and acetylation at the sophorose head group. These and all combinations of modifications described herein are incorporated within this invention.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention. As a single example, one skilled in the art of organic synthesis can use combinations of synthetic techniques described herein to synthesize ring-opened sophorolipid amide derivatives in which the C═C double bond remains intact or is hydrogenated.

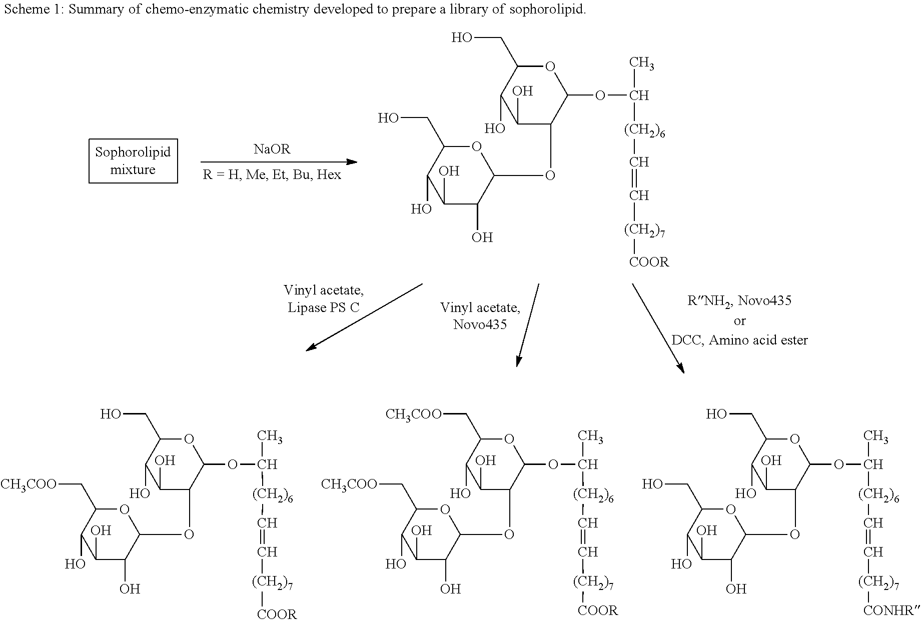

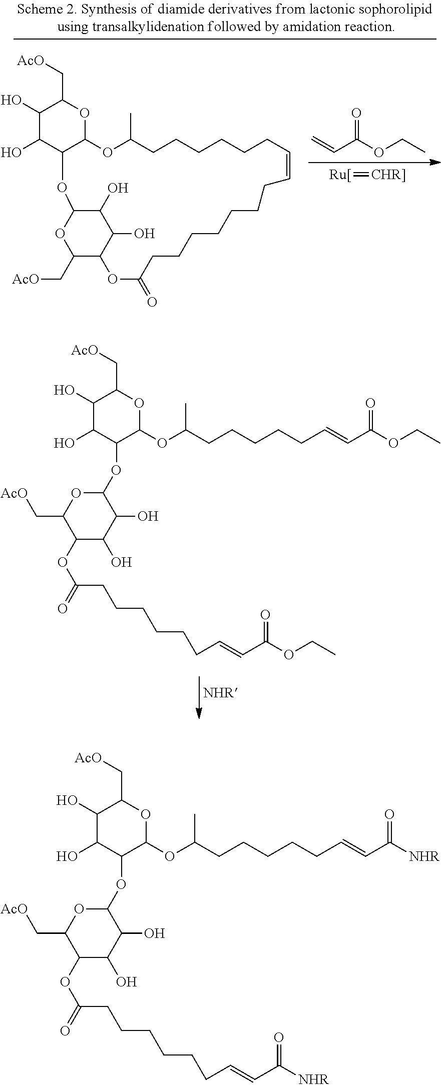

### REFERENCES

Felse, P. A.; Shah, V.; Chan, J.; Rao, K. J.; Gross, R. A., “Sophorolipid biosynthesis by Candida bombicola from industrial fatty acid residues.” Enzyme and Microbial Technology, 40 (2), 316-323 (2007).
Azim, A; Shah, V.; Doncel, G. F.; Peterson, N.; Gao, W.; Gross, R. “Amino acid conjugated sophorolipids: A new family of biologically active functionalized glycolipids.” Bioconjugate Chemistry 17 (6): 1523-1529 (2006).
Zhang, L.; Somasundaran, P.; Singh, S. K.; Felse, A. P.; Gross, R. A. “Synthesis and interfacial properties of sophorolipid derivatives.” Colloids and Surfaces A: Physicochem. Eng. Aspects; 240; 75-82 (2004).
Singh, S. K.; Felse, A. P.; Nunez, A.; Foglia, T. A.; Gross, R. A. “Regioselective Enzyme-Catalyzed Synthesis of Sophorolipid Esters, Amides and Multifunctional Monomers.” J. Org. Chem.; 68; 5466-5477 (2003).
Guilmanov, V.; Ballistreri, A.; Impallomeni, G.; Gross, R. A. “Oxygen Transfer Rate and Sophorose Lipid Production by Candida bombicola.” Biotechnol. and Bioeng.; 77(5), 489-494 (2002).
Bisht, K.; Gross, R.; Kaplan, D. “Enzyme-Mediated Regioselective Acylations of Sophorolipids.” J. Org. Chem., 64:3, 780-789 (1999).
Marchal, R.; Lemal, J.; Sulzer, C. Method of production of sophorosides by fermentation with fed batch supply of fatty add esters or oils, U.S. Pat. No. 5,616,479, 1997.
Trummler, K.; Effenberger, F.; Syldatk, C. An integrated microbial/enzymatic process for production of rhamnolipids and L-(+)-rhamnose from rapeseed oil with Pseudomonas sp. DSM 2874. Eur. J. Lipid Sci. Technol. 2003, 105, 563-571.
Monteiro, L. M.; Lione, V. F.; do Carmo, F. A.; do Amaral, L. H.; da Silva, J. H.; Nasciutti, L. E.; Rodrigues, C. R.; Castro, H. C.; de Sousa, V. P.; Cabral, L, M. Development and characterization of a new oral dapsone nanoemulsion system: permeability and in silico bioavailability studies. Int. J. Nanomedicine.; 7; 5175-5182 (2012).
Cutter, C. N.; Willett, J. L.; Siragusa, G. R. “Improved antimicrobial activity of nisin-incorporated polymer films by formulation change and addition of food grade chelator.” Let. Appl. Microbiol.; 33; 325-328 (2001)

What is claimed is:

1. A method for controlling pests, comprising the steps of;
(a) modifying derivatives of sophorolipids (SL); and
(b) applying the modified sophorolipid derivatives (MSL) to the plant pathogen or to an environment in which the pathogens may occur or are located in an amount such that the pathogens are substantially controlled.

2. The method as claimed in claim 1, wherein the modified sophorolipid derivatives are obtained through chemical modifications of the natural sophorolipids.

3. The method as claimed in claim 2, wherein the modified sophorolipid derivatives are obtained without purifying the reaction mixture or pure compounds of the same.

4. The method as claimed in claim 2, wherein the modified sophorolipid derivatives are obtained from pure natural sophorolipid mixtures or crude natural sophorolipid or the mixture directly collected from fermentation culture broth.

5. The method as claimed in claim 1, wherein the pathogens are selected from the group consisting of; bacteria, fungi and viruses or it can be used for other plant pests.

6. The method as claimed in claim 2, wherein the modified sophorolipid derivatives are synthesized from a natural sophorolipid produced with oleic acid, canola oil, rapeseed oil and any other vegetable oil or fatty acid source with saturation and unsaturation(s) in the fatty acid chains.

7. The method as claimed in claim 2, wherein modified sophorolipid derivatives includes an active component that is selected from the group consisting of: purified or unpurified modified sophorolipid derivative; combination of modified sophorolipid derivatives; combination of modified sophorolipid derivative with natural sophorolipid; combination of modified sophorolipid derivative with chemical or biobased emulsifiers, biosurfactants, surfactants, and eco-friendly organic solvents used in pesticide formulation.

8. The method as claimed in claim 7, wherein the modified sophorolipid derivatives includes an inactive component that is selected from the group consisting of: inert ingredients used in formulation of pesticides, biopesticides and biochemical pesticides as adjuvents, buffering agents or pH adjusting agents/salts and solubilizers.

9. The method as claimed in claim 7, wherein the physical form of formulated modified sophorolipid derivatives includes wettable powders, powders, dust, granules, liquids, gels, semisolids, colloidal materials, paste and in any other form a potential pesticide, biopesticide and biochemical pesticide can be formulated.

10. The method as claimed in claim 8, wherein a member of the group of inert components may be used as an adjuvant or may possess pesticidal activity,
wherein preferred adjuvants or pesticidal components are those of natural origin that compliment the natural aspects of the modified sophorolipid derivative biopesticides and can be (a) an oil component such as cinnamon oil, dove oil, cottonseed oil, garlic oil, or rosemary oil; (b) another natural biosurfactant or synthetic surfactant; or (c) an aldehyde such as cinnamic aldehyde, and
wherein other oils that may be used as a pesticidal component or adjuvants are selected from the group consisting of: almond oil, camphor oil, castor oil, cedar oil, citronella oil, citrus oil, coconut oil, corn oil, eucalyptus oil, fish oil, geranium oil, lecithin, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil, and
wherein other suitable additives are all substances that are customarily used for such preparations, and are selected from the group consisting of adjuvants, surfactants, emulsifying agents, plant nutrients, fillers, plasticizers, lubricants, glidants, colorants, pigments, bittering agents, buffering agents, solubility controlling agents, pH adjusting agents, preservatives, stabilizers and ultra-violet light resistant agents, and
wherein stiffening or hardening agents can be incorporated to strengthen the formulations and make them strong enough to resist pressure or force in certain applications such as sod, root flare or tree injection tablets.

11. The method as claimed in claim 8, wherein the buffering agents are selected from the group consisting of organic and amino acids or their salts, wherein suitable buffers include citrate, gluconate, tartrate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof, phosphoric and phosphorous acids or their salts, natural buffers, and synthetic buffers.

12. The method as claimed in claim 8, wherein solubility control agents or excipients may be used in the formulations to control the release of the active substances, the solubility control agents or excipients selected from the group consisting of wax, chitin, chitosan, C12-C20 fatty adds such as myristic add, stearic add, palmitic add; C12-C20 alcohols such as lauryl alcohol, cetyl alcohol, myristyl alcohol, and stearyl alcohol; amphipilic esters of fatty adds with glycerol, especially monoesters C12-C20 fatty adds such as glyceryl monolaurate, glyceryl monopalmitate; glycol esters of fatty adds such polyethylene monostearate or polypropylenemonopalmitate glycols; C12-C20 amines such lauryl amine, myristyl amine, stearyl amine, and amides of C12-C20 fatty adds.

13. The method as claimed in claim 8, wherein the pH adjusting agents are selected from the group consisting of potassium hydroxide, ammonium hydroxide, potassium carbonate or bicarbonate, hydrochloric add, nitric add, sulfuric add or a mixture thereof.

14. The method as claimed in claim 8, further comprising additional components, wherein the additional components is included in aqueous preparation formulations as a salt form of polyprotic adds, and are selected from the group consisting of sodium bicarbonate, sodium carbonate, sodium sulfate, sodium phosphate, sodium biphosphate.

15. The method as claimed in claim 7, wherein the synthetic surfactant to be used in formulation is selected from the group consisting of: alkyl betaines, alkyl sulfates, alkyl ammonium bromide derivatives, alkyl phenol ethoxylates, alkyl ethylene or polyethylene ethoxylates, alkyl or acyl glycosides, tween 80, tween 60, tween 40, tween 20, and biosurfactants.

16. The method as claimed in claim 7, wherein the biosurfactants to be used in formulation along with the modified sophorolipid derivatives for formulation are selected from the group consisting of glycolipids, rhamnolipids, mannosylerythritol, cellobiose lipids, trehalose lipids, emulsan, lipopeptides, surfactin, lipoproteins, lipopolysaccharide-protein complexes, phospholipids, and polysaccharide-protein-fatty add complexes and other compound(s) with potential uses as a biosurfactant.

17. The method as claimed in claim 16, wherein the biosurfactants or surface active compounds to be used in formulations along with the modified sophorolipid derivatives are pure, crude or directly collected from culture broth or the culture broth having surface active agents in it.

18. The method as claimed in claim 8, wherein the biopesticide is applied by direct injection, spraying, pouring, dipping, in the form of concentrated or diluted liquids, solutions, suspensions, powders, and the like, containing such concentrations of the active agent as is most suited for a particular purpose at hand, and wherein the biopesticide is applied as is or reconstituted prior to use.

19. The method as claimed in claim 8, wherein the modified sophorolipid derivative is in a solid formulation having a form or shape selected from the group consisting of cylinders, rods, blocks, capsules, tablets, pills, pellets, strips, and spikes, milled, granulated, powdered, or is in a semi solid formulation that can be prepared in paste, wax, gel, or cream preparations.

20. The method as claimed in claim 8, wherein the biopesticide is used for human or animal applications; the formulations is prepared in liquid, paste, ointment, suppository, capsule or tablet forms; the formulations are encapsulated using components known in the pharmaceutical industry so as to protect the components from undesirable reactions and help the ingredients resist adverse conditions in the environment or the treated object or body e.g. stomach.

21. The method as claimed in claim 8, wherein the biopesticide compositions are applied to the plants, pests, or soil using methods of application depending on the certain circumstances.

22. The method as claimed in claim 8, wherein the biopesticide compositions are used to introduce the active compounds into the soil, wherein the biopesticide compositions are incorporated into the soil in the vicinity of the roots of the plants, and wherein the biopesticide compositions are in the form of liquid, bait, powder, dusting, granules, tablets, spikes, rods, or other shaped moldings.

23. The method as claimed in claim 8, wherein the biopesticide compositions is used for treating individual plant, tree, plants or trees; the biopesticide compositions are molded into different shapes or forms; the biopesticide compositions are a solid, paste or gel, or liquid; the biopesticide compositions are introduced into the vascular tissue of the plants; the shapes or forms are tablets, capsules, plugs, rods, spikes, films, strips, nails, or plates; and the shapes or forms are introduced into pre-drilled holes into the plants or root flares, or pushed or punched into the cambium layer.

24. The method as claimed in claim 8, wherein the modified sophorolipid compositions are dispensed using dispensing devices selected from the group consisting of syringes, pumps or caulk guns, paste-tubes or plunger tubes for delivering semi-solid formulations into drilled holes in tree trunks or root flares.

25. The method as claimed in claim 8, wherein the biopesticide compositions are applied in the form of paste, gel, coatings, strips, or plasters onto the surface of the plant, a plaster or strip may be in a semi-solid formulation in which an insecticide placed on the side that will contact the tree, bush, or rose during the treatment, and wherein the same strip may have glue or adhesive at one or both ends to wrap around or stick to the subject being treated.

26. The method as claimed in claim 8, wherein the biopesticide compositions are sprayed or dusted on the leaves in the form of pellets, spray solution, granules, or dust.

27. The method as claimed in claim 8, wherein the solid or semi-solid compositions are coated using film-coating compounds used in the pharmaceutical industry such as polyethylene glycol, gelatin, sorbitol, gum, sugar or polyvinyl alcohol; wherein film coating protects a handler from coming in direct contact with the active ingredient in the formulations; and wherein, in addition, a bittering agent such as denatonium benzoate or quassin is incorporated in the pesticidal formulations, the coating or both.

28. The method as claimed in claim 8, wherein the concentrations of the ingredients in the formulations and application rate of the compositions are varied depending on the pest, plant or area treated, or method of application; and wherein the compositions and methods are used to control a variety of pests selected from the group consisting of insects and other invertebrates, algae, microbial pests, and weeds or other plants.

29. The method as claimed in claim 1, wherein the sophorolipid derivative has the formula: 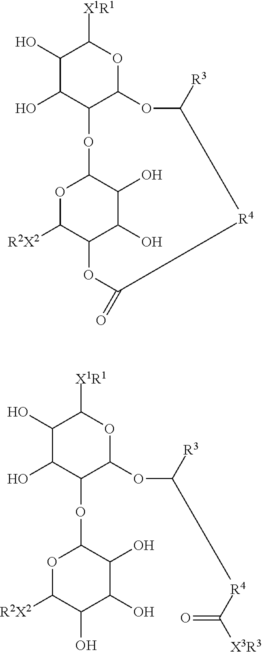
wherein X¹ or X² is oxymethyl (—CH₂O—) or methylene (—CH₂—);
R¹ and/or R² is selected from the following functional groups: hydrogen, acetyl, acryl, urethane, hydroxyalkyl, ether, halide, carboxyalkyl or alkyl containing heteroatoms (1°, 2°, and 3° amino, tetraalkylammonium, sulfate, phosphate);
R³ can be a hydrogen or alkyl group;
R⁴ is an alkyl chain that normally has between 9 and 19 carbons and normally has unsaturation (C═C bond) at one or more sites;
X³ can contain heteroatoms; and
The combination of X³R³ can be selected from the following functional groups: hydroxy, alkanethiolate, amide, alkanamide, alkanamide containing heteroatoms (1°, 2°, and 3° amino, tetraalkylammonium), alkylsulfate, alkylphosphate, carbohydrate, mono- or oligopeptide with 2-50 amino acids.

30. The method as claimed in claim 29, wherein R⁴ is an alkyl chain that normally has 15 carbons and normally has unsaturation (C═C bond) at one or more sites.

31. The method as claimed in claim 29, wherein the sophorolipid derivatives comprise modifying unsaturated (C═C) bonds within R⁴ to be saturated by hydrogenation, epoxidized, hydroxylated by hydrolysis of the epoxide or hydroboration oxidation or dihydroxylation using osmium tetroxide, or converted to a dithiirane, alkyl aziridine, cyclopropyl, thioalkane derivative.

32. The method as claimed in claim 29, wherein the X3 heteroatoms are selected from the group consisting of O, S, and NH.

33. The method of claim 1, wherein the sophorolipid derivative has the formula: 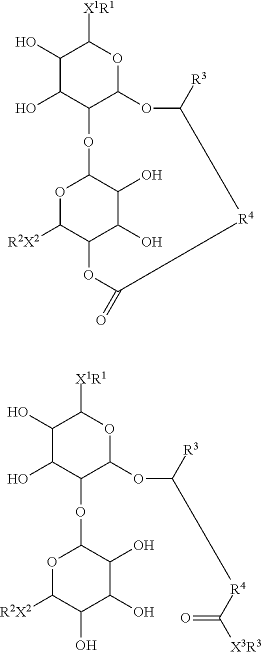
wherein X¹ or X² is carbonyl (—C═O—);
R¹ and/or R² can be selected from the following groups: hydroxyl, amide, alkanamide, alkanamide containing heteroatoms (1°, 2°, and 3° amino, tetraalkylammonium), alkylsulfate, alkylphosphate, carbohydrate, mono- or oligopeptide;
R³ can be a hydrogen or alkyl group;
R⁴ is an alkyl chain that normally has between 9 and 19 carbons and normally has unsaturation (C═C bond) at one or more sites;
X³ can contain heteroatoms (e.g., O, S, NH); and
The combination of X³R³ can be selected from the following functional groups: hydroxy, alkanethiolate, amide, alkanamide, alkanamide containing heteroatoms (1°, 2°, and 3° amino, tetraalkylammonium), alkylsulfate, alkylphosphate, carbohydrate, mono- or oligopeptide with 2-50 amino acids.

34. The method as claimed in claim 33, wherein R⁴ is an alkyl chain that normally has 15 carbons and normally has unsaturation (C═C bond) at one or more sites.

35. The method as claimed in claim 33, wherein the sophorolipid derivatives comprise modifying unsaturated (C═C) bonds within R⁴ to be saturated by hydrogenation, epoxidized, hydroxylated by hydrolysis of the epoxide or hydroboration oxidation or dihydroxylation using osmium tetroxide, or converted to a dithiirane, alkyl aziridine, cyclopropyl, thioalkane derivative.

36. The method as claimed in claim 33, wherein the X3 heteroatoms are selected from the group consisting of O, S, and NH.
